(19) United States
(12) Patent Application Publication
(10) Pub. No.: US 2026/0140855 A1
(43) Pub. Date: May 21, 2026

(54) AUTOMATED AGENT TESTING AND EVALUATION USING LARGE LANGUAGE MODELS

(71) Applicant: Salesforce, Inc., San Francisco, CA (US)

(72) Inventors: Manjeet Singh, San Francisco, CA (US); Jonathon Neal Moore, Indianapolis, IN (US); Avi Shah, San Francisco, CA (US); Deepak Mukunthu, Bellevue, WA (US); Nabil Naffar, Tel Aviv (IL); Magic Johnson, Palo Alto, CA (US); Sky Chen, Palo Alto, CA (US); Reddy Yerradoddi, San Francisco, CA (US)

(21) Appl. No.: 19/394,674

(22) Filed: Nov. 19, 2025

Related U.S. Application Data
(60) Provisional application No. 63/722,388, filed on Nov. 19, 2024.

(51) Int. Cl. G06F 11/3668; G06F 11/3604

(52) U.S. Cl. CPC G06F 11/3688; G06F 11/3616; G06F 11/3684

(57) ABSTRACT

A system may utilize a large language model (LLM). The system may train and test agents via an LLM by using the LLM to generate a set of scenarios and a set of training data and then training the agents using the training data and executing the agents accordingly. The system may also perform evaluations of data within a data table via LLMs and evaluations of prompt templates using a set of data from the data table. In one example, the system may receive a set of instructions for data evaluation, evaluate the set of data via the LLM, and obtain a set of output data from the LLM. In another example, the system may receive a prompt template for the LLM, execute the prompt template via the LLM, obtain a set of output data from the LLM, and evaluate the performance of the prompt template via the LLM.

### CROSS REFERENCE

The present Application for Patent claims the benefit of U.S. Provisional Ser. No. 63/722,388 by Singh et al., entitled “AUTOMATED AGENT TESTING AND EVALUATION USING LARGE LANGUAGE MODELS,” filed Nov. 19, 2024, assigned to the assignee hereof, and expressly incorporated by reference herein.

### FIELD OF TECHNOLOGY

The present disclosure relates generally to database systems and data processing, and more specifically to automated agent testing and evaluation using large language models (LLMs).

### BACKGROUND

A cloud platform (i.e., a computing platform for cloud computing) may be employed by multiple users to store, manage, and process data using a shared network of remote servers. Users may develop applications on the cloud platform to handle the storage, management, and processing of data. In some cases, the cloud platform may utilize a multi-tenant database system. Users may access the cloud platform using various user devices (e.g., desktop computers, laptops, smartphones, tablets, or other computing systems, etc.).

In one example, the cloud platform may support customer relationship management (CRM) solutions. This may include support for sales, service, marketing, community, analytics, applications, and the Internet of Things. A user may utilize the cloud platform to help manage contacts of the user. For example, managing contacts of the user may include analyzing data, storing and preparing communications, and tracking opportunities and sales.

In some examples, users or organizations may use a relatively large quantity agents to perform a relatively large quantity of tasks, including tasks that involve multiple agents interacting with each other. However, training and testing agents to perform tasks may be relatively complex. For example, users may have to manually generate training data and testing scenarios which may be relatively time-consuming. Further, as the agents may be updated and retrained, having a user perform such updating and (re)training may be relatively time-consuming, resource computationally expensive, and inefficient, thus resulting in relatively unreliable agents. Moreover, training and testing agents using relatively large sets of data, different prompts, different models, may be relatively time consuming, computationally expensive, and complex. Additionally, or alternatively, data tables may be used for evaluating data and users may be restricted with how to input data within data tables, use the input data, and evaluate the input data, resulting in relatively inefficient data evaluation procedures.

### BRIEF DESCRIPTION OF THE DRAWINGS

FIG. 1 illustrates an example of a computing system that supports automated agent testing and evaluation using large language models (LLMs) in accordance with aspects of the present disclosure.

FIG. 2 shows an example of a computing system that supports automated agent testing and evaluation using LLMs in accordance with aspects of the present disclosure.

FIG. 3 shows an example of a flowchart that supports automated agent testing and evaluation using LLMs in accordance with aspects of the present disclosure.

FIGS. 4 and 5 show examples of a user interface that supports automated agent testing and evaluation using LLMs in accordance with aspects of the present disclosure.

FIG. 6 shows an example of a process flow that supports automated agent testing and evaluation using LLMs in accordance with aspects of the present disclosure.

FIG. 7 shows an example of a user interface that supports automated agent testing and evaluation using LLMs in accordance with aspects of the present disclosure.

FIG. 8 shows an example of a process flow that supports automated agent testing and evaluation using LLMs in accordance with aspects of the present disclosure.

FIG. 9 shows a block diagram of an apparatus that supports automated agent testing and evaluation using LLMs in accordance with aspects of the present disclosure.

FIG. 10 shows a block diagram of a data generation module that supports automated agent testing and evaluation using LLMs in accordance with aspects of the present disclosure.

FIG. 11 shows a diagram of a system including a device that supports automated agent testing and evaluation using LLMs in accordance with aspects of the present disclosure.

FIG. 12 shows a block diagram of an apparatus that supports automated agent testing and evaluation using LLMs in accordance with aspects of the present disclosure.

FIG. 13 shows a block diagram of a data sheet module that supports automated agent testing and evaluation using LLMs in accordance with aspects of the present disclosure.

FIG. 14 shows a diagram of a system including a device that supports automated agent testing and evaluation using LLMs in accordance with aspects of the present disclosure.

FIGS. 15 through 17 show flowcharts illustrating methods that support automated agent testing and evaluation using LLMs in accordance with aspects of the present disclosure.

### DETAILED DESCRIPTION

In some examples, users may use generative artificial intelligence (AI) systems to perform tasks such as content creation. In some cases, generative AI models such as large language models (LLMs) may be a subset of AI models and machine learning (ML) models (e.g., AI/ML models) that utilize algorithms and models to create content, such as text, images, audio, and video, by learning patterns from existing data. In some cases, users may also use agents (e.g., AI agents or non-human identities (NHIs)) which may be autonomous software entities designed to perform specific tasks or actions by processing and interpreting data. In some examples, an agent may use one or more AI/ML models (e.g., LLMs) to execute natural language queries and interact with users or systems. In some cases, users or organizations may use a relatively large quantity agents to perform a relatively large quantity of tasks, including tasks that involve multiple agents interacting with each other. However, training and testing agents to perform tasks may be relatively complex. For example, users may have to manually generate training data and testing scenarios which may be relatively time-consuming. Further, as the agents may be updated and retrained, having a user perform such updating and (re)training may be relatively time-consuming, resource computationally expensive, and inefficient, thus resulting in relatively unreliable agents. Additionally, or alternatively, training and testing agents using relatively large sets of data, different prompts, different models, may be relatively time consuming, computationally expensive, and complex. These technical challenges create specific computational inefficiencies, including exponential increases in training time as agent complexity grows, memory bottlenecks when processing large multi-agent interaction datasets, and system failures when agents encounter edge cases not covered by manually generated scenarios. Traditional approaches fail to provide the technical scalability and reliability required for enterprise-level agent deployment.

To enhance the training and utilization of agents the techniques of the present disclosure may enable the generation of testing scenarios and training data for agents and the utilization of an interactive data table. For example, in accordance with the techniques of the present disclosure, an agent testing generation service that is associated with an LLM may receive a selection of one or more agents to perform a first task and each agent may be associated with a set of parameters for performing one or more actions via AI/ML models. The LLM may then generate a set of scenarios for testing the one or more agents that correspond to the one or more actions each agent is instructed to perform. Moreover, the LLM may generate a set of training data, based on generating the set of scenarios, for training the one or more agents to perform the first task. In response, the agent testing generation service may train the AI/ML models of the agents using the set of training data generated by the LLM and execute the agents to perform the first task based on the training. The set of parameters may include: (i) agent configuration data comprising model type identifiers, temperature settings, token limits, and API endpoint specifications; (ii) behavioral parameters defining response patterns, interaction protocols, and decision tree structures; (iii) task-specific metadata including input/output schemas, data validation rules, and performance thresholds; (iv) execution parameters such as timeout values, retry logic, error handling procedures, and resource allocation limits; and (v) inter-agent communication protocols defining data exchange formats, message routing algorithms, and synchronization mechanisms that ensure deterministic multi-agent interactions.

Further, in accordance with the techniques of the present disclosure, an LLM service may utilize an interactive data table for data evaluation and LLM prompt evaluation to ensure reliability and accuracy of the agents. For example, for data evaluation, the LLM service may obtain a set of data within the interactive data table and receive a set of instructions for evaluation of the set of within the interactive data table by an LLM. In response, the LLM may use the set of instructions to evaluate at least a subset of the set of data to obtain a set of output data that is displayed within the interactive data table. Further, for prompt evaluation, the LLM service may receive a prompt template that includes a set of instructions for the LLM to evaluate the set of data obtained from the interactive data table. The LLM service may then execute the prompt template to obtain a set of output data and use the LLM to evaluate the set of output data to obtain an indication of a performance of the prompt template. Therefore, the techniques of the present disclosure, may enable relatively more reliable and efficient techniques for training agents, utilizing agents to evaluate data and perform actions, and for evaluating the performance of prompts for agents to improve the performance of agents and increase the efficiency and reliability of utilizing agents within a system.

In some examples, the generation of the training data and testing scenarios for the selected agents may be for training the selected agents to perform the first task where each of the agents perform actions sequentially. For example, the first task may involve the selected agents to interact with each other. That is, an output of a first agent may be given as an input to a second agent to perform a respective task. In such examples, training the agents to perform one or more actions and to perform actions as part of a task that involves multiple agents may be relatively complex. Thus, the techniques of the present disclosure may reduce the complexity of training agents for tasks that involve interactions between multiple agents. Further, the set of data within the interactive data table may be obtained from user inputs, a file that includes the set of data being imported, or from an LLM. For example, the LLM service may enable users to generate data for testing agents on-demand via an LLM, thus improving the agent testing capabilities. Additionally, or alternatively, users may use prompt templates to perform actions on relatively large sets of data and then evaluate the output of an LLM using the prompt templates to determine the performance of the prompt template. Based on the performance of the prompt template, a user or system may further determine whether a prompt template should be updated or changed. Therefore, the techniques of the present disclosure may enable automatic agent testing and training sequential agent execution and a utilization of an interactive data table for data evaluation and prompt evaluation to improve the performance, accuracy, efficiency, and reliability of agents within a system.

Aspects of the disclosure are initially described in the context of an environment supporting an on-demand database service. Additional aspects of the disclosure are described with reference to a computing system, a flowchart, user interfaces, and process flow. Aspects of the disclosure are further illustrated by and described with reference to apparatus diagrams, system diagrams, and flowcharts that relate to automated agent testing and evaluation using LLMs.

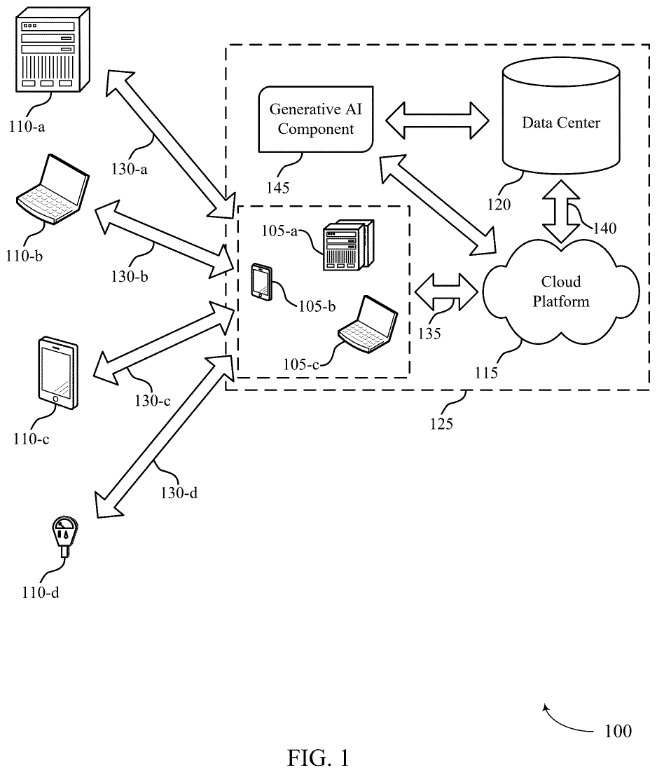

FIG. 1 illustrates an example of a system 100 for cloud computing that supports automated agent testing and evaluation using LLMs in accordance with various aspects of the present disclosure. The system 100 includes cloud clients 105, contacts 110, cloud platform 115, and data center 120. Cloud platform 115 may be an example of a public or private cloud network. A cloud client 105 may access cloud platform 115 over network connection 135. The network may implement transfer control protocol and internet protocol (TCP/IP), such as the Internet, or may implement other network protocols. A cloud client 105 may be an example of a user device, such as a server (e.g., cloud client 105-a), a smartphone (e.g., cloud client 105-b), or a laptop (e.g., cloud client 105-c). In other examples, a cloud client 105 may be a desktop computer, a tablet, a sensor, or another computing device or system capable of generating, analyzing, transmitting, or receiving communications. In some examples, a cloud client 105 may be operated by a user that is part of a business, an enterprise, a non-profit, a startup, or any other organization type.

A cloud client 105 may interact with multiple contacts 110. The interactions 130 may include communications, opportunities, purchases, sales, or any other interaction between a cloud client 105 and a contact 110. Data may be associated with the interactions 130. A cloud client 105 may access cloud platform 115 to store, manage, and process the data associated with the interactions 130. In some cases, the cloud client 105 may have an associated security or permission level. A cloud client 105 may have access to certain applications, data, and database information within cloud platform 115 based on the associated security or permission level and may not have access to others.

Contacts 110 may interact with the cloud client 105 in person or via phone, email, web, text messages, mail, or any other appropriate form of interaction (e.g., interactions 130-a, 130-b, 130-c, and 130-d). The interaction 130 may be a business-to-business (B2B) interaction or a business-to-consumer (B2C) interaction. A contact 110 may also be referred to as a customer, a potential customer, a lead, a client, or some other suitable terminology. In some cases, the contact 110 may be an example of a user device, such as a server (e.g., contact 110-a), a laptop (e.g., contact 110-b), a smartphone (e.g., contact 110-c), or a sensor (e.g., contact 110-d). In other cases, the contact 110 may be another computing system. In some cases, the contact 110 may be operated by a user or group of users. The user or group of users may be associated with a business, a manufacturer, or any other appropriate organization.

Cloud platform 115 may offer an on-demand database service to the cloud client 105. In some cases, cloud platform 115 may be an example of a multi-tenant database system. In this case, cloud platform 115 may serve multiple cloud clients 105 with a single instance of software. However, other types of systems may be implemented, including—but not limited to—client-server systems, mobile device systems, and mobile network systems. In some cases, cloud platform 115 may support CRM solutions. This may include support for sales, service, marketing, community, analytics, applications, and the Internet of Things. Cloud platform 115 may receive data associated with contact interactions 130 from the cloud client 105 over network connection 135, and may store and analyze the data. In some cases, cloud platform 115 may receive data directly from an interaction 130 between a contact 110 and the cloud client 105. In some cases, the cloud client 105 may develop applications to run on cloud platform 115. Cloud platform 115 may be implemented using remote servers. In some cases, the remote servers may be located at one or more data centers 120.

Data center 120 may include multiple servers. The multiple servers may be used for data storage, management, and processing. Data center 120 may receive data from cloud platform 115 via connection 140, or directly from the cloud client 105 or an interaction 130 between a contact 110 and the cloud client 105. Data center 120 may utilize multiple redundancies for security purposes. In some cases, the data stored at data center 120 may be backed up by copies of the data at a different data center (not pictured).

Subsystem 125 may include cloud clients 105, cloud platform 115, and data center 120. In some cases, data processing may occur at any of the components of subsystem 125, or at a combination of these components. In some cases, servers may perform the data processing. The servers may be a cloud client 105 or located at data center 120.

The system 100 may be an example of a multi-tenant system. For example, the system 100 may store data and provide applications, solutions, or any other functionality for multiple tenants concurrently. A tenant may be an example of a group of users (e.g., an organization) associated with a same tenant identifier (ID) who share access, privileges, or both for the system 100. The system 100 may effectively separate data and processes for a first tenant from data and processes for other tenants using a system architecture, logic, or both that support secure multi-tenancy. In some examples, the system 100 may include or be an example of a multi-tenant database system. A multi-tenant database system may store data for different tenants in a single database or a single set of databases. For example, the multi-tenant database system may store data for multiple tenants within a single table (e.g., in different rows) of a database. To support multi-tenant security, the multi-tenant database system may prohibit (e.g., restrict) a first tenant from accessing, viewing, or interacting in any way with data or rows associated with a different tenant. As such, tenant data for the first tenant may be isolated (e.g., logically isolated) from tenant data for a second tenant, and the tenant data for the first tenant may be invisible (or otherwise transparent) to the second tenant. The multi-tenant database system may additionally use encryption techniques to further protect tenant-specific data from unauthorized access (e.g., by another tenant).

Additionally, or alternatively, the multi-tenant system may support multi-tenancy for software applications and infrastructure. In some cases, the multi-tenant system may maintain a single instance of a software application and architecture supporting the software application in order to serve multiple different tenants (e.g., organizations, customers). For example, multiple tenants may share the same software application, the same underlying architecture, the same resources (e.g., compute resources, memory resources), the same database, the same servers or cloud-based resources, or any combination thereof. For example, the system 100 may run a single instance of software on a processing device (e.g., a server, server cluster, virtual machine) to serve multiple tenants. Such a multi-tenant system may provide for efficient integrations (e.g., using application programming interfaces (APIs)) by applying the integrations to the same software application and underlying architectures supporting multiple tenants. In some cases, processing resources, memory resources, or both may be shared by multiple tenants.

As described herein, the system 100 may support any configuration for providing multi-tenant functionality. For example, the system 100 may organize resources (e.g., processing resources, memory resources) to support tenant isolation (e.g., tenant-specific resources), tenant isolation within a shared resource (e.g., within a single instance of a resource), tenant-specific resources in a resource group, tenant-specific resource groups corresponding to a same subscription, tenant-specific subscriptions, or any combination thereof. The system 100 may support scaling of tenants within the multi-tenant system, for example, using scale triggers, automatic scaling procedures, scaling requests, or any combination thereof. In some cases, the system 100 may implement one or more scaling rules to enable relatively fair sharing of resources across tenants. For example, a tenant may have a threshold quantity of processing resources, memory resources, or both to use, which in some cases may be tied to a subscription by the tenant.

In some examples, the system 100 may include a generative artificial intelligence (AI) component 145. The generative AI component 145 may be an example or a component of a LLM, such as a generative AI model. In some examples, the generative AI component 145 may additionally, or alternatively, be referred to as any of an AI, a generative AI (GAI), a GAI model, an LLM, a machine learning model, or any similar terminology. The generative AI component 145 may be a model that is trained on a corpus of input data, which may include text, images, video, audio, structured data, or any combination thereof. Such data may represent general-purpose data, domain-specific data, or any combination thereof. Further, the generative AI component 145 may be supplemented with additional training on data associated with a role, function, or generation outcome to further specialize the generative AI component 145 and increase the accuracy and relevance of information generated with the generative AI component 145.

In some examples, the cloud platform 115 may receive a query from a cloud client 105 that may include a request to produce a response (e.g., text, images, video, audio, or other information) to the query using the generative AI component 145. The cloud platform 115 may input a prompt to the generative AI component 145 that includes, or otherwise indicates, the query (or information included therein). The generative AI component 145 may generate an output (e.g., text, images, video, audio, or other information) that is responsive to the prompt. In some examples, the cloud platform 115 may modify or supplement one or more aspects of the query to increase the quality of the response. In some examples, such modification or supplementation may be referred to as grounding.

The system 100 may support any configuration for the use of generative AI models. In FIG. 1, the generative AI component 145 is depicted as being located external to the subsystem 125. However, the generative AI component 145 may be hosted on the cloud platform 115, elsewhere within the subsystem 125, or outside the subsystem 125 (e.g., a publicly-hosted platform). Additionally, or alternatively, multiple generative AI components 145 may be employed to perform one or more of the actions described as being performed by a single generative AI component 145. Further, in some examples, the generative AI component 145 may communicate with one or more other elements, such as a contact 110, the data center 120, one or more other elements, or any combination thereof, to receive additional information (e.g., that may be indicated in the query or the prompt) that is to be considered for performing generative processes.

In various implementations, the models and/or modules described herein (e.g., including, but not limited to, the generative AI component 145) may be classification, predictive, generative, conversational, or another form of AI technology, such as AI model(s), agents, etc., implementing one or more forms of machine learning, a neural network, statistical modeling, deep learning, automation, natural language processing, or other similar technology. The AI technology may be included as part of a network or system comprising a hardware-or software-based framework for training, processing, fine-tuning, or performing any other implementation steps. Furthermore, the AI technology may include a hardware-or software-based framework that performs one or more functions, such as retrieving, generating, accessing, transmitting, etc. The AI technology may be implemented by a computer including a register coupled with a processor or a central processing unit (CPU).

Moreover, the AI technology may be trained or fine-tuned using supervised, unsupervised, or other AI training techniques. In various implementations, the AI technology may be trained or fine-tuned using a set of general datasets or a set of datasets directed to a particular field or task. Additionally, or alternatively, the AI technology may be intermittently updated at a set interval or in real time based on resulting output or additional data to further train the AI technology. The AI technology may offer a variety of capabilities including text, audio, image, and other content generation, translation, summarization, classification, prediction, recommendation, time-series forecasting, searching, matching, pairing, and more. These capabilities may be provided in the form of output produced by the AI technology in response to a particular prompt or other input. Furthermore, the AI technology may implement Retrieval-Augmented Generation (RAG) or other techniques after training or fine-tuning by accessing a set of documents or knowledge base directed to a particular field or website other than the training or fine-tuning data to influence the AI technology's output with the set of documents or knowledge base.

To further guide and train output of the AI technology, one or more input prompts may be provided to the AI technology for the purpose of eliciting particular responses. In various implementations, the input prompts may correspond to the particular field or task to which the AI technology is trained. Additionally, or alternatively, the AI technology may be implemented along with one or more additional AI technologies. For example, a first AI model may produce a first output, which is used as input for a second AI model to produce a second output. These AI technologies may be used in succession of one another, in parallel with another, or a combination of both. Furthermore, the AI technologies may be merged in a variety of implementations, for example, by bagging, boosting, stacking, etc. the AI technologies.

In some examples of the system 100, users operating on contacts 110 or cloud clients 105 may use agents associated with the generative AI component 145 to perform tasks or actions by processing and interpreting data (e.g., data from the user, the cloud platform 115, the data center 120, other cloud clients 105, other contacts 110, or any combination thereof). Further, in some cases, users or organizations may use a relatively large quantity agents to perform a relatively large quantity of tasks, including tasks that involve multiple agents interacting with each other. However, training and testing agents to perform tasks may be relatively complex. For example, users may have to manually generate training data and testing scenarios which may be relatively time-consuming. Further, as the agents may be expected to be updated and retrained, having a user perform such training may be relatively time-consuming, resource computationally expensive, and inefficient, thus resulting in unreliable agents. Additionally, or alternatively, training and testing agents using large sets of data, different prompts, different models, may be relatively time consuming and computationally expensive and complex. Therefore, in some examples, the training and testing of agents associated with the generative AI component 145 may result in the agents being inaccurate and uncapable of performing tasks for users

For example, a user may select one or more agents to utilize for determining whether a customer should be part of a marketing campaign based on a likelihood that a user will purchase a product of an organization. In some cases, such task may involve interaction between the one or more agents. For example, a first agent may be used to obtain information about a user, a second agent may be used to obtain data associated with how the user has historically responded or interacted with marketing campaigns, and a third agent may be used to obtain a semantic score for the user and the organization (e.g., a score indication a user's opinions or feelings for the organization). In such cases, the third agent may use the output of the first agent and the second agent as input, the second agent may use the output of the first agent as input, and the output of the first agent, the second agent, and the third agent may be used as input to a fourth agent to generate a likelihood score indicating how a likelihood that the user purchases a product. In such cases, training such agents may be relatively complex. For example, the fourth agent should be trained and tested on various different sets of data and for different scenarios However, generating enough test cases and corresponding training data to effectively and efficiently train the agents to generate an accurate likelihood score may be relatively time-consuming and computationally expensive. Therefore, in accordance with the techniques of the present disclosure, an agent training service may use a testing generation service that is associated with the generative AI component 145 may obtain a selection of one or more agents to perform a task and then use an LLM to generate a set of scenarios for testing the one or more agents and to generate a set of training data, based on generating the set of scenarios, for training the one or more agents. The agent training service may then train the ML models of the agents using the set of training data generated by the LLM and execute the agents to perform the first task based on the training.

Further, in some examples of the system 100, agents may utilize data within data tables (e.g., data within the cloud platform 115, the data center 120, or both) for testing and training. In some cases, the data within the data tables may be manually inputted or imported into the data table and may be static within the data tables (e.g., the data may not change). However, utilizing static data may result in the actions performed by the agents being inaccurate as conditions change. Therefore, the techniques of the present disclosure may describe utilizing an interactive data table for testing agents associated with the generative AI component 145. For example, in accordance with the techniques of the present disclosure, an LLM service that is associated with the generative AI component 145, may utilize an interactive data table for data evaluation and LLM prompt evaluation to ensure reliability and accuracy of the agents.

The interactive data table may a multi-modal LLM integration architecture that enables real-time processing of heterogeneous data types. The system may employ: (i) a dynamic schema inference engine that automatically detects data types and relationships within the interactive data table; (ii) streaming data processors that handle large datasets through chunked processing and incremental updates; (iii) a context-aware prompt generation system that dynamically constructs LLM queries based on data characteristics and user instructions; (iv) a result caching and memorization layer that optimizes repeated operations on similar data; and (v) a conflict resolution system for handling concurrent user modifications and LLM updates. This multi-modal integration architecture specifically improves computer functionality by reducing memory fragmentation through optimized data chunking, minimizing API call overhead through intelligent result caching, and limiting system deadlocks through the conflict resolution mechanisms. These improvements address specific technical limitations of conventional data processing systems when handling concurrent LLM operations and large-scale data manipulation tasks.

In some examples, for data evaluation, the LLM service may evaluate at least a subset of a set of data within an interactive data table to obtain a set of output data that is displayed within the interactive data table. For example, the interactive data table may include a set of columns or fields that include data and the LLM service (e.g., the generative AI component 145) may receive a set of instructions to evaluate the data within one or more fields of the set of fields of the interactive data table. Based on receiving the instructions, the LLM service may execute the set of instructions to generate a set of output data that indicates the data evaluation, and the set of output data may be displayed within the interactive data table. The technical innovation lies in the seamless integration of structured data operations with unstructured LLM processing, enabling users to perform complex analytical operations that would traditionally require separate tools and manual data transformation steps. Moreover, utilizing the interactive data for the data evaluation may enable users to evaluate different types of data relatively efficiently and view the evaluations for additional control.

The disclosed system provides measurable technical improvements over conventional agent training approaches. Specifically, the automated scenario generation reduces training data preparation time by eliminating manual data entry bottlenecks, while the LLM-driven approach ensures comprehensive edge case coverage that manual methods typically miss. The interactive data table architecture enables real-time data validation and processing that prevents the data inconsistency errors common in static table implementations. These technical improvements result in more reliable agent deployment with reduced system failures and improved computational efficiency in multi-agent environments.

Further, for prompt evaluation, the LLM service may receive a prompt template that includes a set of instructions for the LLM to evaluate the set of data obtained from the interactive data table. In some cases, the prompt template may be used to generate an output from a relatively large set of data. For example, the interactive data table may indicate multiple columns or fields that include data and to perform actions, such as content generation, using the data within multiple fields, a user may generate the prompt template to reference the multiple fields. Thus, the prompt template may be capable of accessing the data within the multiple fields and using an LLM to evaluate the data and perform actions on the data for row of the interactive data table. Moreover, once the content is generated by the LLM, the user may utilize the LLM to evaluate a performance of the prompt template in generating accurate and reliable content. Therefore, the techniques of the present disclosure, may improve the performance of agents and increase the efficiency and reliability of utilizing agents within the system 100 by enabling relatively more reliable and efficient techniques for training agents, utilizing agents to evaluate data and perform actions, and for evaluating the performance of prompts for agents.

It should be appreciated by a person skilled in the art that one or more aspects of the disclosure may be implemented in a system 100 to additionally, or alternatively, solve other problems than those described above. Furthermore, aspects of the disclosure may provide technical improvements to “conventional” systems or processes as described herein. However, the description and appended drawings only include example technical improvements resulting from implementing aspects of the disclosure, and accordingly do not represent all of the technical improvements provided within the scope of the claims.

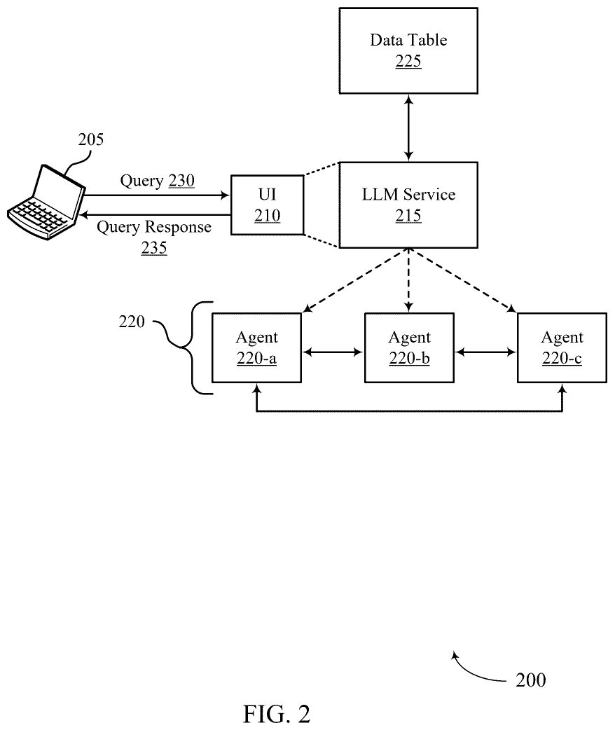

FIG. 2 shows an example of a computing system 200 that supports automated agent testing and evaluation using LLMs in accordance with aspects of the present disclosure. In some examples, the computing system 200 implements or may be implemented by the system 100. For example, the computing system 200 may illustrate a computing device 205, a user interface 210, an LLM service 215, one or more agents 220 (e.g., an agent 220-a, an agent 220-b, and an agent 220-c), and a data table 225, that may be implemented by devices or services described with reference to FIG. 1.

In some examples, users may use generative AI services such as the LLM service 215 to generate content based on natural language queries (e.g., a query 230). For example, a user may transmit, via a computing device 205, the query 230 to a user interface 210 of the LLM service 215 that is a natural language query requesting the LLM service 215 to generate a set of content for the user. In response, the user may receive a query response 235 that includes the content requested by the user via the query 230. For example, the query 230 may be a request to generate a set of text for an electronic communication message (e.g., an email or text message) and the LLM service 215 may process the query 230 to generate the query response 235 In some examples, the query 230 may include various types of requests, such as data retrieval, content generation, or task execution. Further, the query response 235 may include text, images, audio, or other types of content (e.g., multi-modal content) based on the nature of the query 230. Moreover, in some cases, the LLM service 215 may transmit the query response 235 back to the user of the computing device 205 for the user to review. The query response 235 may also be used as input for further processing or actions by other components of the computing system 200.

In some cases, users may use the LLM service 215 to control one or more agents 220. The one or more agents 220 may represent autonomous software entities configured to perform specific tasks or actions by processing and interpreting data. In some examples, the one or more agents 220 may interact with or utilize one or more AI/ML models (e.g., LLMs) to execute natural language queries and interact with users or systems. Further, the one or more agents 220 may be associated with a set of parameters that indicate the behavior and actions of the one or more agents 220. Additionally, or alternatively, the one or more agents 220 may interact with other agents 220 to perform various tasks. For example, the agent 220-a may interact with the agent 220-b and the agent 220-c to perform a single task. Thus, the output of one agent 220 may serve as input for another agent 220, enabling complex interactions and task execution. For example, the agent 220-a may receive a first input (e.g., an initial input) and generate a first output which is further utilized as an input to the agent 220-b. In such cases, the agent 220-b may receive a second input from the agent 220-a where the second input corresponds to, is associated with, or is the same as the first output generated by the agent 220-a. The agent 220-b may utilize the second input to generate a second output which is further given to the agent 220-c as a third input for the agent 220-c to generate a third output (e.g., a final result to the initial input) In such cases, the first output and the second input may be the same and the second output and the third input may be the same as the output of one agent 220 may serve as input for another agent 220.

To enable the one or more agents 220 to perform tasks (e.g., to perform tasks individually or collectively or to perform tasks sequentially or in parallel), the one or more agents 220 may be trained and tested to perform various tasks. In some examples, a user may use a data table 225 to store data for training and testing the one or more agents 220. In some cases, users may manually enter data into the data table 225 or users may import data into the data table 225 from one or more files. As such, the one or more agents 220 may be trained and tested on the data within the data table 225. Moreover, to efficiently train and test the one or more agents 220, the one or more agents 220 may be expected to be trained and tested on a relatively large set of data.

In some cases, organizations may train and test the one or more agents 220 on relatively large sets of data to ensure that the outputs of the one or more agents 220 are accurate and reliable. For example, some organizations or industries may expect a level of accuracy and a lack of failure in order to use agents 22 to perform tasks on the behalf of a user due to regulations associated with the industry. For example, the medical industry is highly regulated and may expect a level of accuracy and reliability of the one or more agents 220. However, the testing and training of the one or more agents 220 may be manual and can be relatively time consuming. For example, a relatively large set of data may have to be generated and manually input into the data table 225 or into a file that can be imported into the data table 225 such that the one or more agents 220 can be trained and tested. Further, the testing of the one or more agents 220 may include a relatively large set of testing scenarios and the testing may be expected to changes as the agents 220 are further developed (e.g., testing may have to change throughout a development lifecycle). Such testing procedures may result in the testing of the one or more agents 220 and the generation of testing scenarios being relatively complex. Additionally, or alternatively, testing (e.g., batch testing) multiple different prompts or models via the LLM service 215, multiple different agents 220, or both may be relatively complex, time-consuming, and computationally expensive.

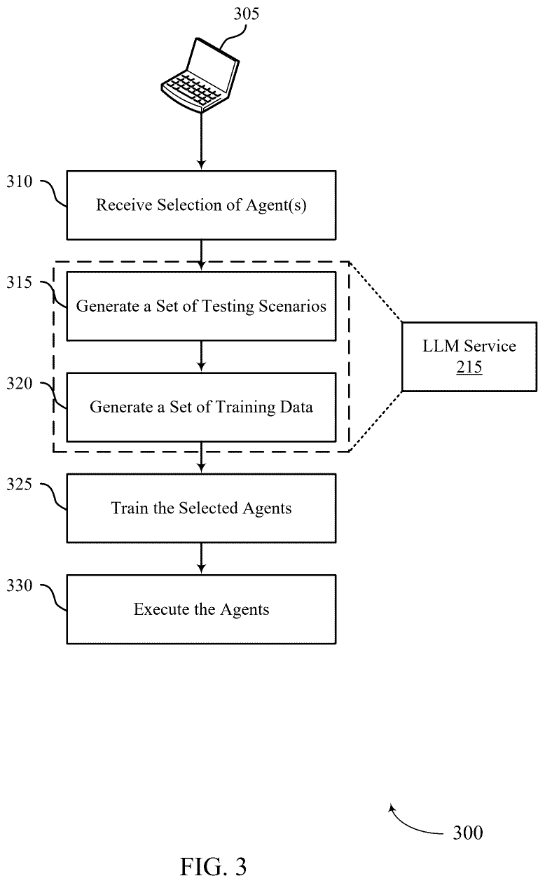

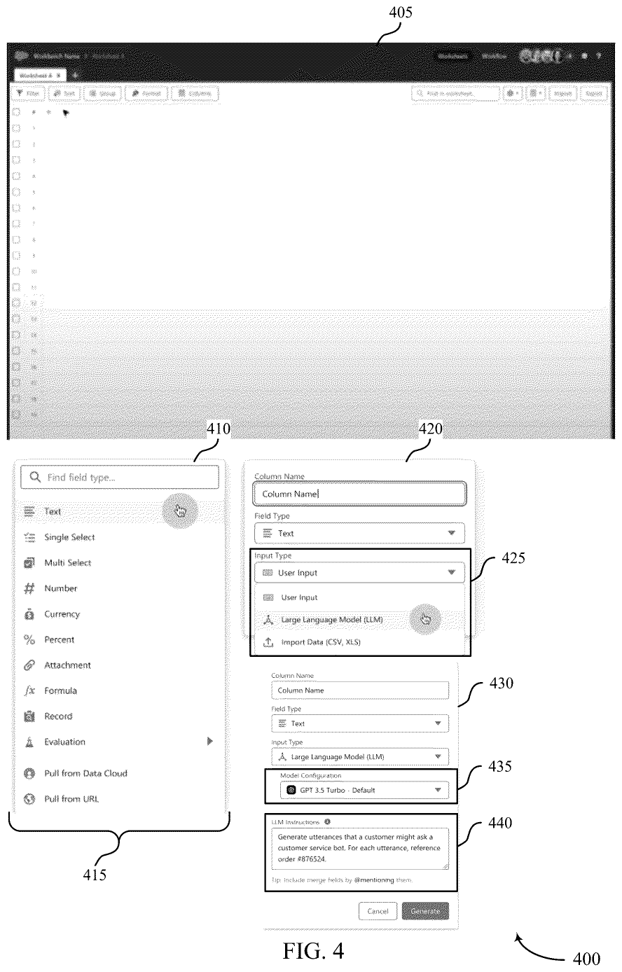

In accordance with the techniques of the present disclosure, the LLM service 215 and the one or more agents 220 may be utilized to aid in training and testing the one or more agents 220, evaluating data via the one or more agents 220, and evaluating the performance of prompts used by an LLM for the one or more agents 220. For example, as described elsewhere herein, such as with reference to FIG. 3, the techniques of the present disclosure may describe the LLM service 215 generating testing scenarios and training data based on information associated with one or more agents 220 that are selected for a task. For example, a user may select one or more agents 220 to perform a first task and the LLM service 215 may automatically generate data for testing and training the one or more agents 220 to perform the respective task. Further, as described elsewhere herein, such as with reference to FIGS. 4 through 8, the techniques of the present disclosure may describe the data table 225 being an interactive data table to provide flexibility and efficiency in inputting data for training and testing the one or more agents or generating, via the LLM service 215, data for training and testing the one or more agents. Further, in accordance with the techniques of the present disclosure, the interactive data table and the LLM service 215 may be utilized for evaluating outputs from the one or more agents 220 utilizing the LLM service 215 and the data of the interactive data table, evaluating the performance of prompts for the one or more agents 220 utilizing the LLM service 215, or any combination thereof.

FIG. 3 shows an example of a flowchart 300 that supports automated agent testing and evaluation using LLMs in accordance with aspects of the present disclosure. The operations of the flowchart 300 may be implemented by an agent training service or its components as described herein. In some examples, an agent training service may execute a set of instructions to control the functional elements of the agent training service to perform the described functions. Additionally, or alternatively, the agent training service may perform aspects of the described functions using special-purpose hardware.

At 310, a LLM service 215 may receive, from a first user operating a computing device 305 and via a first user interface, a selection of one or more agents from a set of agents to perform a first task. The set of agents may be associated with one or more AI/ML models to execute natural language queries. Each agent may be associated with a set of parameters for performing one or more actions via the one or more AI/ML models. In some examples, the LLM service 215 may receive, via the selection of the one or more agents, an indication of the first task for the one or more agents to perform. Further, in response to receiving the selection of the one or more agents, the LLM service 215 may obtain the set of parameters for each agent of the one or more agents. In some examples, the set of parameters for the agents may include agent details, topics, instructions, actions, metadata, or any combination thereof associated with the agents. For example, the set of parameters may indicate identifiers associated with the agent, topics that the agent is configured for, instructions for the ML models of the agent, actions that the agent is configured to perform, metadata associated with the agent, or any combination thereof.

At 315, the LLM service 215 may generate a set of scenarios for testing the one or more agents. The set of scenarios may correspond to the one or more actions each agent of the one or more agents is instructed to perform based on the set of parameters of each agent. That is, the LLM service 215 may automatically create a testing plan for testing the one or more agents based on the parameters of the one or more agents. In some examples, the set of scenarios may be based on an agent job to be done (JBTD) or the actions that the agent is configured to perform as part of execution of the first task. Moreover, in accordance with the techniques of the present disclosure, the LLM service 215 may use an LLM to generate a list of diverse test cases to ensure that the one or more agents are tested for a relatively wide variety of different scenarios. The LLM may generate diverse test cases by: (i) analyzing agent parameter vectors to identify capability boundaries; (ii) applying combinatorial testing algorithms to generate edge case scenarios; (iii) utilizing Monte Carlo sampling techniques to support statistical coverage across parameter spaces; (iv) implementing constraint satisfaction algorithms to generate valid multi-agent interaction sequences; and/or (v) employing adversarial generation techniques to create challenging test scenarios that stress-test agent performance limits.

At 320, the LLM service 215 may generate a set of training data for training the one or more agents to perform the first task. The generation of the set of training data may be based on the generation of the set of scenarios and the set of parameters of the one or more agents. In some examples, generating the set of training data may include the LLM service 215 automatically creating the test cases for the training of the one or more agents. For example, the LLM service 215 may generate a set of test scripts for training the one or more agents on the set of training data. Thus, at 325, an agent training service may train the one or more AI/ML models associated with the one or more agents using the set of training data generated via the LLM service 215. At 330, in response to the one or more AI/ML models of the one or more agents being trained, the agent training service may then execute the one or more agents to perform the first task. In some examples, executing the one or more agents to perform the first task may be based on receiving the indication of the first task. Further, in some cases, the one or more agents may be executed sequentially to perform the first task. For example, an output of a first agent may be used as an input to a second agent in order to perform the first task using the one or more agents.

Further, in some examples, based on executing the one or more agents, the LLM service 215 may obtain, from the one or more AI/ML models associated with the one or more agents, a set of output data in response to the set of training data being provided as input to the one or more AI/ML models. Moreover, the set of output data may be associated with the first task. Using the set of output data, the LLM service 215 may evaluate the set of output data to obtain a performance metric indication of the one or more agents. In some cases, the set of output data may be evaluated via code-based testing, via the LLM service 215, via user feedback, or any combination thereof. For example, the set of output data may be compared to a set of expected output data, a user may rate the set of output data (e.g., a user indicates a positive or negative indication to the output data), or an LLM of the LLM service 215 may evaluate the data based on a set of instructions of LLM prompt. In some cases, when an LLM is being used to evaluate the set of output data, a user may set an evaluation scale for the LLM to evaluate the set of output data. Further descriptions of evaluating data with an LLM associated with the LLM service 215 may be described elsewhere herein, such as with reference to FIGS. 4 through 8.

FIG. 4 shows an example of a user interface 400 that supports automated agent testing and evaluation using LLMs in accordance with aspects of the present disclosure. In some examples, the user interface 400 may implement or may be implemented by the system 100, the computing system 200, or both. For example, the user interface 400 may illustrate a user interface of an interactive data table 405 that is used for training and testing one or more agents as described elsewhere herein including with reference to FIGS. 1 and 2.

In some examples, data tables may be fundamental tools used across various industries for data management and analysis. In some cases, data tables may rely on manual data entry and users importing data from files. However, using AI models (e.g., LLMs), the techniques of the present disclosure may provide enhancements to the functionality and usability of data tables by enabling a relatively more versatile and efficient data input system that leverages the use of LLMs. As illustrated herein and in accordance with the techniques of the present disclosure, the interactive data table 405 may be configured to improve data input and data manipulation procedures. For example, the interactive data table 405 may support multiple data entry techniques such as manual user input, file imports, and data generation using an LLM, thus making data entry relatively more efficient and flexible.

For manual user inputs, users may be capable of manually entering data directly into table cells of the interactive data table 405. In some examples, the interactive data table 405 may also support or include features for data validation, auto-completion, and error correction to assist users in entering accurate and consistent data. Further, the manual user input may be facilitated by the user interface 400 of the interactive data table 405 and may ensure accessible use by users with varying levels of technical expertise. For file imports, users may import data from various different file formats (e.g., comma separated value (CSV) files, spreadsheet files, JavaScript object notation (JSON) files, and the like). In some cases, the interactive data table 405 may automatically parse the imported files and map the data to one or more fields of columns of the interactive data table 405. In some examples, the import functionality may include error handling mechanisms to manage issues such as missing data, incorrect formats, and duplicate entries. Additionally, or alternatively, users may be capable of previewing and editing the imported data within the interactive data table 405 before finalizing the import process to ensure data integrity within the interactive data table 405.

Further, to generate date utilizing LLMs, the interactive data table 405 may interact with an LLM to generate data based on user-defined parameters and prompts. For example, users may indicate a type of data to be generated (e.g., synthetic data for testing, data augmentation for AI/ML models, and the like) and may provide contextual prompts for the LLM to generate the data. Thus, the LLM may analyze the prompts and generate data that is contextually relevant and adheres to criteria indicated by a user. Moreover, the generated data may be directly inserted into the interactive data table 405 for the user, thus providing an efficient data input method for users.

In some examples, when inputting data into the interactive data table 405, the user may utilize a menu 410 to select a field from a set of fields 415 for a column of the interactive data table 405. For example, a user may select to input data for a text field, a single select field, a multi-select field, a numerical field, a currency field, a percentage field, an attachment field, a formula field, a data record field, or an evaluation field. The menu 410 may also give a user an option to pull (e.g., retrieve) data from a cloud platform 115 or from a uniform resource locator (URL) that indicates an address of a unique resource on the internet. Further, using a menu 420, a user may select an input type 425 from a set of input types. For example, a user may select a drop down menu that lists the set of input types 425 for the user to select from. If a user selects user input as the input type 425 for the respective column, the user may then be prompted by the user interface 400 to begin entering data into the interactive data table 405. If the user selects import data as the input type 425, a menu may be displayed via the user interface 400 for the user to select a file from a file manager of a computing device that the user interface 400 is displayed on and is being operated by the user. Further, if the user selects LLM as the input type 425, an LLM configuration display 430 may be displayed within the user interface 400. In some cases, the LLM configuration display 430 may be an extension of the menu 420 or the LLM configuration display 430 may be separate from the menu 420.

Within the LLM configuration display 430, the user may also be capable of selecting a model configuration 435 from a set of model configurations 435. For example, a model configuration 435 field may be displayed via the LLM configuration display 430 and the user may select a drop down arrow to display a drop down menu that lists the set of model configurations 435 that a user is capable of selecting and utilizing to generate data for the respective column. In some cases, the set of model configurations 435 displayed to the user for selection via the LLM configuration display 430 may be based on a field 415 type selected via the menu 410. Further, within the LLM configuration display 430, the user may also input a set of LLM instructions 440 within a text input field of the LLM configuration display 430 to instruct the LLM to generate the set of data for the interactive data table 405.

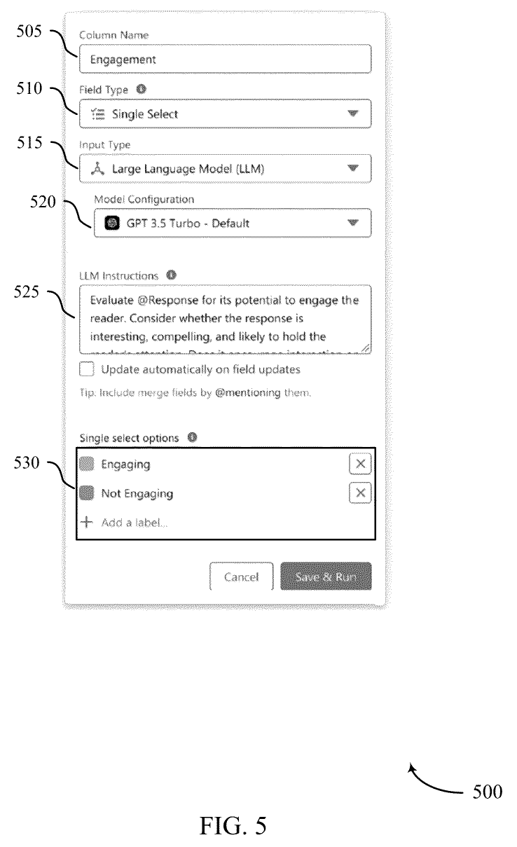

Therefore, by enabling the integration of the LLM for data generation, the relatively time consumption and user effort associated with creating data and populating the interactive data table 405 may be reduced. Further, the LLM may also be used to perform automated data validation and error correction when data is input manually by users or imported via files to improve the data quality of the interactive data table 405 and reduce the quantity of manual corrections expected. Additionally, or alternatively, in accordance with the techniques of the present disclosure, a user may utilize LLM data generation in combination with manual data entry, importing data from a file, or both to improve the data population of the interactive data table 405. For example, a user may import or manually input a relatively small quantity of data into the interactive data table 405 and then use the LLM to generate a relatively larger set of data that includes the initial data. In such cases, if the interactive data table 405 is used for training and testing agents, as described elsewhere herein such as with reference to FIGS. 2 and 3, a user may be capable of creating a relatively large data set for training. Moreover, having the interactive data table 405 allow users to have the ability to input data manually, import from files, or generate the data via an LLM may increase the flexibility of the interactive data table 405 and allow the user to select a data entry technique that is most convenient and efficient for the user. Further, in some cases, the user interface 400 of the interactive data table 405 may also be designed with a user-centric approach to create a user-friendly interface that ensures an ease of use and accessibility for users of different technical skill levels. Additionally, or alternatively, using LLMs for data generation within the interactive data table 405 may ensure that users are capable of producing relatively high quality and contextually relevant data on-demand. Further descriptions of the techniques of the present disclosure such as users generating evaluations for data within the interactive data table 405 using LLMs may be provided elsewhere herein, such as with reference to FIG. 5.

FIG. 5 shows an example of a user interface 500 that supports automated agent testing and evaluation using LLMs in accordance with aspects of the present disclosure. In some examples, the user interface 500 may implement or may be implemented by the system 100, the computing system 200, the user interface 400, or any combination thereof. For example, the user interface 500 may illustrate a user interface for configuring a set of instructions for evaluating a set of data within an interactive data table as described elsewhere herein including with reference to FIGS. 1 and 2. In some cases, the user interface 500 may include a column name field 505, a field type field 510, an input type field 515, a model configuration field 520, an LLM instructions field 525, and an output option field 530.

In some examples, when using an interactive data table (e.g., an interactive data table 405 described with reference to FIG. 4), users may interact with or otherwise utilize LLMs to perform evaluations on various types of data within the interactive data table, such as text data, image data, audio data, and the like. Further, the interactive data table may enable users to input data into a spreadsheet type interface and run (e.g., execute) evaluations by generating instructions for an LLM that reference one or more fields or columns of the interactive data table. Moreover, the LLM may process the data according to a set of specifications indicated by a user and then output a result within a variety of different formats.

For example, as illustrated herein via the user interface 500, the user interface 500 may enable a user to evaluate data within an interactive data sheet in accordance with the techniques of the present disclosure. For example, users may be capable of creating evaluations of data using LLMs by inputting data into an interactive data sheet and generating a set of instructions for the LLM to evaluate the data. In some cases, the set of instructions for the LLM to evaluate the data within the interactive data table may include an indication of one or more columns within the interactive data table for the evaluation. Further, a user may also indicate an output format of the LLM evaluation. For example, the results of the LLM evaluations may be output in various different formats to provide users with the flexibility of tailoring an output to the expectations of a user. In some cases, the output formats that an LLM may support may include a text format for plain text outputs, a number format for numerical outputs, a single tag format for labeling the output with single categorical label, a multiple tag format for labeling the output with multiple categorical labels, a currency format for financial figure outputs, a percentage format for percentage value outputs, or any combination thereof. Additionally, or alternatively, using LLMs for evaluations may enable users to perform various different type of data evaluations with an LLM acting as the judge, thus enhancing the utility of interactive data sheets across different industries, organizations, applications, and the like.

In some cases, to configure the LLM to generate data evaluations, a user may configure the LLM via the user interface 500. For example, a user may indicate a column name in the column name field 505 of the user interface 500 to indicate where the set of output data from the LLM should be displayed or input within an interactive data table. Further, the user may select a field type for the indicated column via the field type field 510 and an input type via the input type field 515. Moreover, in some cases, the field type indicated via the field type field 510 of the user interface 500 may refer to an output type for the set of output data generated by the LLM and the input type field 515 may indicate that the data for the respective column (e.g., the output data) is being generated and input by an LLM. Thus, in response to selecting an LLM input type via the input type field 515, the user interface 500 may then enable the user to select a corresponding model configuration via the model configuration field 520. Moreover, as described elsewhere herein, the model configurations displayed as options for a user to select may be based on the field type of a respective column. Further, the user may also indicate a set of instructions for an LLM to evaluate a set of data within the LLM instructions field 525 and a format for the data evaluation output via the output option field 530.

In some examples, as illustrated herein, the user interface 500 may indicate a configuration for evaluating data for engagement using an LLM. For example, the set of instructions within the LLM instructions field 525 may indicate for then LLM to evaluate data within a response field by referencing the response field within the set of instructions. Further, a user may then indicate an output format via the field type field 510 as a single select type such that the output option field 530 indicates two possible labels for the output data. For example, as illustrated herein, the output option field 530 may indicate an engaging tag and a not engaging tag such that the individual data items within the responses column can be evaluated by the LLM and labeled as engaging or not engaging within an engagement column of the interactive data table. In another example, the LLM may evaluate for politeness of responses within a response column of the interactive data table and may label the data as polite or impolite in a politeness column. Further, in some cases, the LLM may evaluate image data within an image column of the interactive data table. For example, in the context of a medical industry scenario, the image column may include medical x-ray images and the LLM may evaluate the images to detect items such as whether fractures are visible (e.g., via a fracture visible label or a fracture not visible label), whether tumors are visible (e.g., via a tumor visible label or a no tumor visible label), or the like.

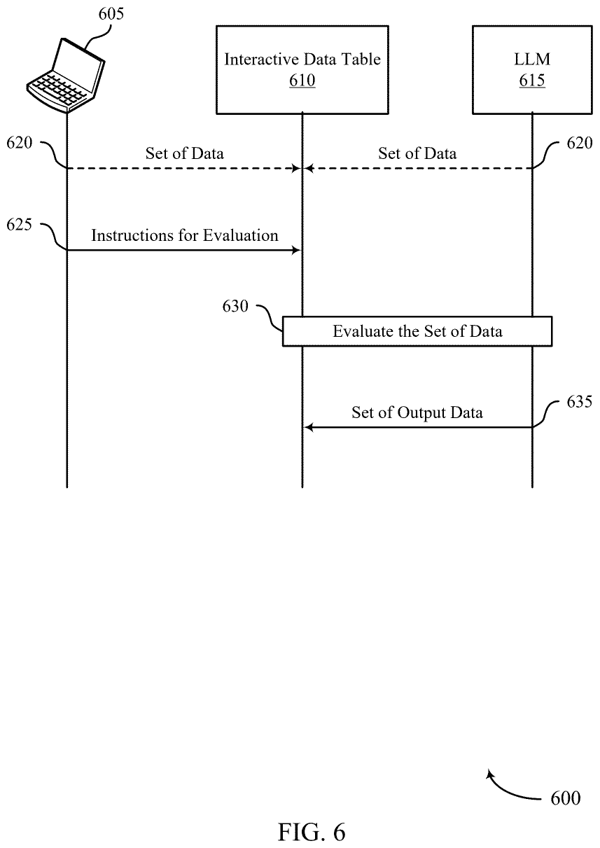

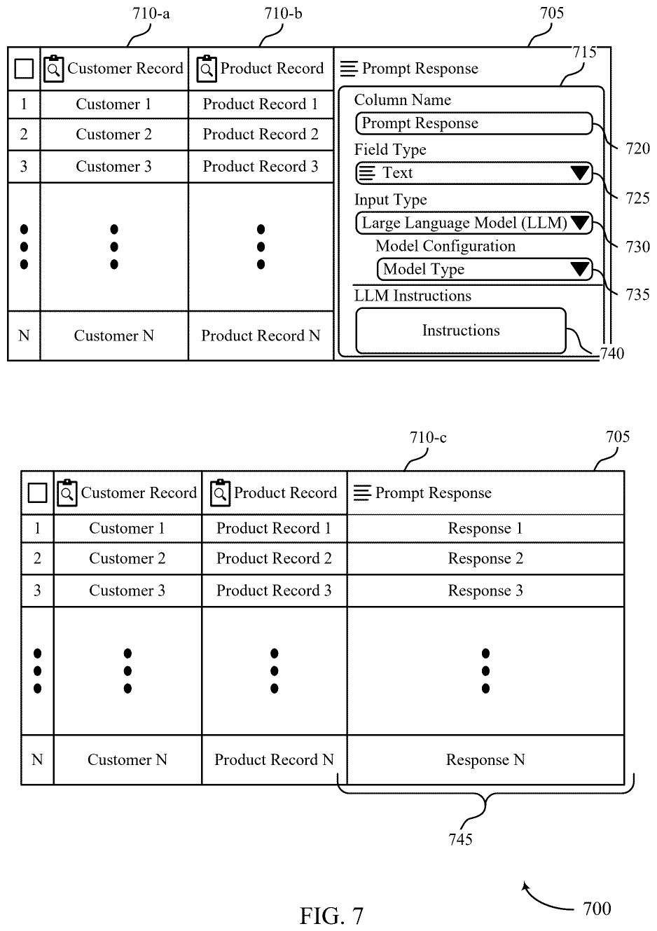

Therefore, in accordance with the techniques of the present disclosure, the user interface 500 may be used for users to define and perform various different types of evaluations. For example, the techniques of the present disclosure may support users using various different data types for evaluation and configuring the LLM evaluations to the expectations and requirements of the user. Moreover, the techniques of the present disclosure may also enable users to generate data for multiple different output formats to ensure that the evaluation results are valuable to the user. Thus, the interactive data table that is configured for intuitive and simple use may allow users to perform data evaluations relatively more efficiently and accurately. Further descriptions of the techniques of the present disclosure may be provided elsewhere herein such as with reference to FIG. 6. Moreover, descriptions of the techniques of the present disclosure related to using prompt templates for data evaluations may be provided elsewhere herein such as with reference to FIG. 7.

FIG. 6 shows an example of a process flow 600 that supports automated agent testing and evaluation using LLMs in accordance with aspects of the present disclosure. In some aspects, the process flow 600 may implement or may be implemented by the system 100, the computing system 200, the user interface 400, the user interface 500, or any combination thereof. The process flow 600 may include a computing device 605, an interactive data table 610, and an LLM 615, which may be examples of devices or services described elsewhere herein including with reference to FIGS. 1 and 2.

In the following description of the process flow 600, the operations may be performed by the computing device 605, the interactive data table 610, and the LLM 615 in different orders or at different times. Some operations may also be left out of the process flow 600, or other operations may be added. Although the process flow 600 may be described as being performed by the computing device 605, the interactive data table 610, and the LLM 615, some aspects of some operations may also be performed by other devices, services, or models described elsewhere herein including with reference to FIGS. 1 through 2.

At 620, the interactive data table 610 may obtain, from a user of the computing device 605, the LLM 615, or both, a set of data via a first user interface within the interactive data table 610. The interactive data table 610 may include a set of fields and the set of fields may include a set of data records from the set of data. In some cases, the interactive data table 610 may obtain the set of data from the first user of the computing device 605 via one or more user inputs comprising the set of data, via an indication of a file comprising the set of data, or a combination thereof. In some other cases, to obtain the set of data from the LLM 615, the interactive data table 610 transmit, to the LLM 615, a query to generate the set of data, the query comprising one or more LLM prompt parameters for the LLM 615 to utilize to generate the set of data. Additionally, or alternatively, the set of data may include text data, a single select data, multi-select data, numerical data, currency data, percentage data, one or more attachments, one or more formulas, record data, one or more images, audio data, or any combination thereof. Further, the set of fields of the interactive data table may be associated with a set of columns of the interactive data table.

At 625, the interactive data table 610 may receive, a set of instructions for evaluation of the set of data by the 615. The set of instructions may include an indication of one or more fields of the set of fields and an output format. Thus, at 630, the LLM 615 may evaluate a subset of data of the set of data within the interactive data table 610 in accordance with the set of instructions for the evaluation. The subset of data may be associated with the one or more fields of the interactive data table indicated via the set of instructions. At 635, the interactive data table 610 may obtain, from the LLM 615 and based on the evaluation, a set of output data within the output format indicated via the set of instructions for the evaluation. In some examples, the set of output data may include textual data, numerical data, single tag data, multiple tag data, currency data, percentage data, or any combination thereof based on the output format indicated via the set of instructions for the evaluation of the set of data. In some cases, the set of output data may be displayed via the first user interface of the computing device 605 within an output field of the set of fields of the interactive data table. In some other cases, the interactive data table 610 may obtain, from one or more user inputs or from the LLM 615, an evaluation of the set of output data.

FIG. 7 shows an example of a user interface 700 that supports automated agent testing and evaluation using LLMs in accordance with aspects of the present disclosure. In some examples, the user interface 700 may implement or may be implemented by the system 100, the computing system 200, or both. For example, the user interface 700 may illustrate a user interface of an interactive data table 705 that is used for training and testing one or more agents as described elsewhere herein including with reference to FIGS. 1 and 2.

In some examples, the interactive data table 705 may be used for data processing and natural language processing using LLMs. In some cases, the interactive data table 705 may allow for users to input data and organize data into various columns where each column can include different types of data, such as text data, numerical data, dates, and other relevant information. Further, in accordance with the techniques of the present disclosure, the interactive data table 705 may be used for batch testing prompt templates with LLMs. In some cases, to batch test prompt templates for LLMs using the interactive data table 705, users may indicate or reference merge field data of different columns of the interactive data table 705 within a prompt template. A merge field may refer to a field or column of the interactive data table 705 that is references within a set of instructions for an LLM with a given symbol or non-letter and non-numerical character (e.g., the ‘@’ symbol) to indicate that the column indication should be replaced with the data from the column. Further, using prompt templates with varied inputs and outputs may allow users to evaluate the effectiveness and accuracy of the prompts.

In accordance with the techniques of the present disclosure, to batch test prompt templates using the interactive data table 705, data may be input and organized into columns of the interactive data table 705. For example, a first set of data may be input into the column 710-a and a second set of data may be input into the column 710-b. A user may then generate prompt templates that reference one or more columns in the interactive data table 705 (e.g., the column 710-a and the column 710-b) as merge tags. An LLM may further process the prompt templates using the indicated data and a user or LLM may evaluate the output of the LLM responses across various data inputs to determine the performance and accuracy of the prompts. Moreover, the techniques of the present disclosure may be adaptable for a wide range of applications involving text data and other types of input data as described elsewhere herein.

In some examples, within a column configuration display 715, a user may configure an LLM to generate a set of data that is an output of an evaluation of the data within the column 710-a and the column 710-b of the interactive data table 705. For example, within the column configuration display 715, a user may generate a column name within a column name field 720, select a field type for the column within a field type field 725, and select an input type for the column within an input type field 730. In response to an LLM input type being selected within the input type field 730, the user may select, via a model configuration field 735 a model configuration for the LLM and based on the field type indicated via the field type field 725 and the user may input a set of instructions for a prompt template within an LLM instructions field 740.

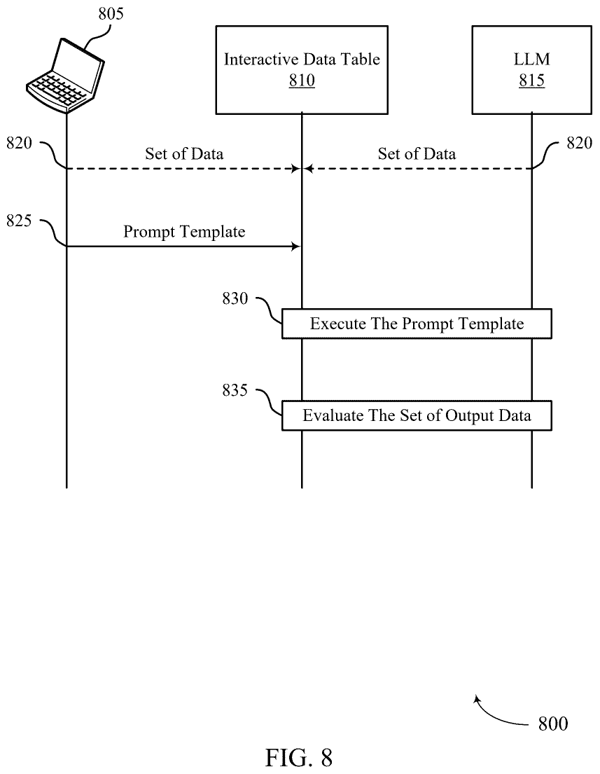

In some examples, as illustrated herein, the column 710-a may represent a column indicating a set of customer records and the column 710-b may represent a column indicating a set of product records associated with the corresponding set of customer records. Moreover, the column configuration display 715 may indicate a configuration of a prompt response column where data for the column is to be generated via a set of LLM instructions indicated via the LLM instructions field 740. Further, the set of LLM instructions may reference the column 710-a and the column 710-b as merge tags. For example, the set of LLM instructions may indicate: “Please draft an email to @CustomerName thanking them for their purchase of @ProductName” where “@CustomerName” and “@ProductName” are merge tags referencing columns in the interactive data table 705. In response, the LLM may generate the data using the prompt template and input the data (e.g., a set of output data 745) into a column 710-c that may represent a column indicating prompt responses. Further, the LLM process the templates by merging the data from the indicated columns and transmitting the completed prompts to the LLM. The LLM may further generate responses based on the merged prompts, thus enabling users to perform batch testing by evaluating how the LLM responds to different inputs. Additionally, or alternatively, the LLM responses may be output back into the interactive data table 705 (e.g., into the column 710-c) to allow users to review and evaluate the performance of the prompt templates. In some examples, such evaluation may include evaluating metrics such as coherence, relevance, and accuracy of the responses. Further, in some examples, the LLM or a different LLM may be used to evaluate the performance of the prompt templates. Thus, the interactive data table 705 may be used to input and organize data for use by LLM prompt templates and the output of the LLM prompt templates can be displayed within the interactive data table 705 for further evaluation to improve the performance of the prompt templates. Further descriptions of techniques of the present disclosure may be describe elsewhere herein, such as with reference to FIG. 8. The lexical analyzer may employ finite state machine algorithms for efficient token recognition, while the dependency graph builder may implement topological sorting algorithms to optimize processing sequences. The type-safe data binding system prevents runtime errors through compile-time validation, and the batch optimization engine reduces computational overhead through intelligent operation grouping and parallel processing techniques.

The merge field processing system may implement a sophisticated template parsing and data substitution engine. The system may use: (i) a lexical analyzer that tokenizes prompt templates and identifies merge field references using configurable delimiter patterns; (ii) a dependency graph builder that analyzes inter-field relationships and determines optimal processing order; (iii) a type-safe data binding system that validates data compatibility between merge fields and target LLM input requirements; (iv) a batch optimization engine that groups similar merge operations to reduce LLM API calls; and (v) a rollback mechanism that handles partial failures in multi-field substitution operations. The system maintains referential integrity by tracking data lineage from source fields through template processing to final LLM output, supporting precise error attribution and debugging capabilities.

FIG. 8 shows an example of a process flow 800 that supports automated agent testing and evaluation using LLMs in accordance with aspects of the present disclosure. In some aspects, the process flow 800 may implement or may be implemented by the system 100, the computing system 200, the user interface 700, any combination thereof. The process flow 800 may include a computing device 805, an interactive data table 810, and an LLM 815, which may be examples of devices or services described elsewhere herein including with reference to FIGS. 1 and 2.

In the following description of the process flow 800, the operations may be performed by the computing device 805, the interactive data table 810, and the LLM 815, in different orders or at different times. Some operations may also be left out of the process flow 800, or other operations may be added. Although the process flow 800 may be described as being performed by the computing device 805, the interactive data table 810, and the LLM 815, some aspects of some operations may also be performed by other devices, services, or models described elsewhere herein including with reference to FIGS. 1 through 2.

At 820, the interactive data table 810 may obtain, from a user of the computing device 805, the LLM 815, or both, a set of data via a first user interface within an interactive data table 810. The interactive data table 810 may include a set of fields and the set of fields may include a set of data records from the set of data. In some examples, the set of data may include text data, a single select data, multi-select data, numerical data, currency data, percentage data, one or more attachments, one or more formulas, record data, one or more images, audio data, or any combination thereof.

At 825, the interactive data table 810 may receive, from the computing device 805, a prompt template for the LLM 815 that is associated with evaluation of the set of data obtained via the first user interface. The prompt template may include a set of instructions for the LLM to evaluate the set of data. The set of instructions may include an indication of one or more fields of the set of fields of the interactive data table.

At 830, the interactive data table 810 may execute, via the LLM 815 and based on receiving the prompt template, the set of instructions of the prompt template using the set of data within the interactive data table to obtain a set of output data. In some cases, to execute the prompt template, the interactive data table 810 may obtain, from the set of data within the interactive data table 810, a subset of data associated with the one or more fields indicated via the set of instructions. Further, the interactive data table 810 may transmit, to the LLM 815, the set of instructions of the prompt template with the subset of data included within the set of instructions in place of the indication of the one or more fields. Moreover, in some examples, the interactive data table 810 may obtain the set of output data may be obtained the subset of data being included within the set of instructions. In some other cases, the set of output data may be displayed via the first user interface within an output field of the set of fields of the interactive data table 810. Further, at 835, the interactive data table 810 may evaluate, via the LLM 815, the set of output data in response to executing the prompt template to obtain one or more indications of a performance of the prompt template. In some examples, the one or more indications of the performance of the prompt template may include a coherency indication, a relevance indication, an accuracy indication, or any combination thereof.

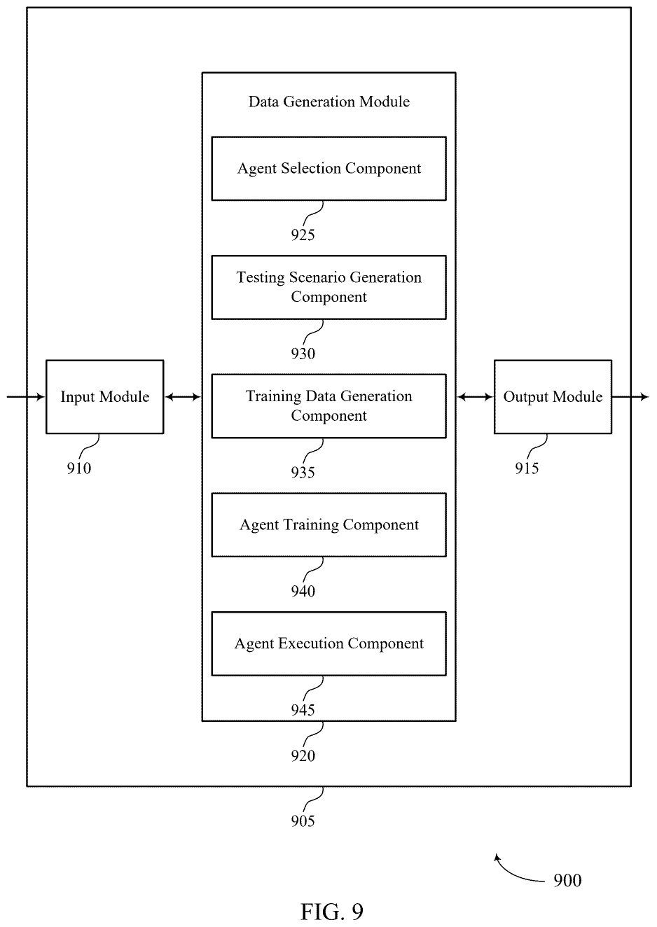

FIG. 9 shows a block diagram 900 of a device 905 that supports automated agent testing and evaluation using LLMs in accordance with aspects of the present disclosure. The device 905 may include an input module 910, an output module 915, and a data generation module 920. The device 905, or one or more components of the device 905 (e.g., the input module 910, the output module 915, the data generation module 920), may include at least one processor, which may be coupled with at least one memory, to support the described techniques. Each of these components may be in communication with one another (e.g., via one or more buses).

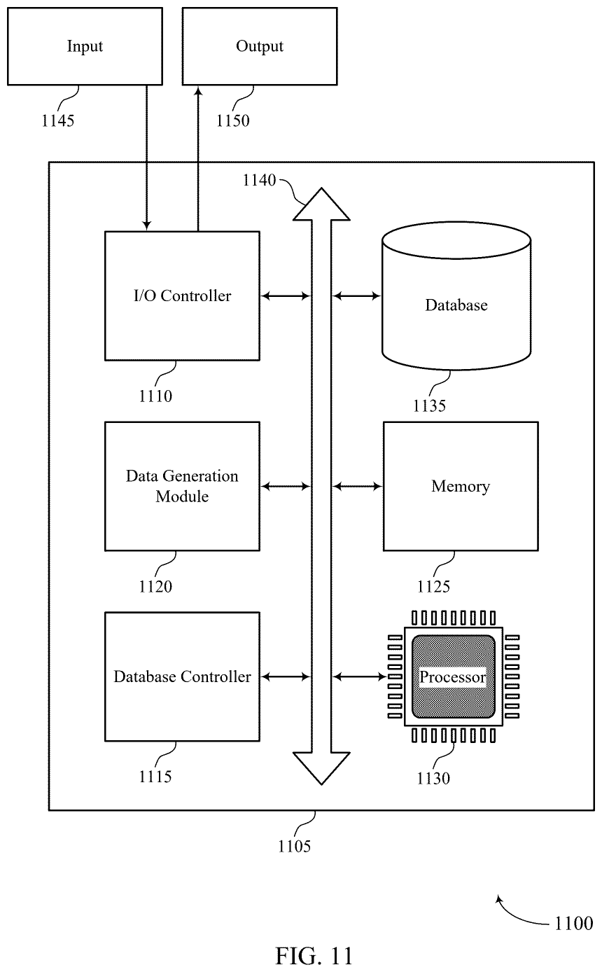

The input module 910 may manage input signals for the device 905. For example, the input module 910 may identify input signals based on an interaction with a modem, a keyboard, a mouse, a touchscreen, or a similar device. These input signals may be associated with user input or processing at other components or devices. In some cases, the input module 910 may utilize an operating system such as iOS®, ANDROID®, MS-DOS®, MS-WINDOWS®, OS/2®, UNIX®, LINUX®, or another known operating system to handle input signals. The input module 910 may send aspects of these input signals to other components of the device 905 for processing. For example, the input module 910 may transmit input signals to the data generation module 920 to support automated agent testing and evaluation using LLMs. In some cases, the input module 910 may be a component of an input/output (I/O) controller 1110 as described with reference to FIG. 11.

The output module 915 may manage output signals for the device 905. For example, the output module 915 may receive signals from other components of the device 905, such as the data generation module 920, and may transmit these signals to other components or devices. In some examples, the output module 915 may transmit output signals for display in a user interface, for storage in a database or data store, for further processing at a server or server cluster, or for any other processes at any number of devices or systems. In some cases, the output module 915 may be a component of an I/O controller 1110 as described with reference to FIG. 11.

For example, the data generation module 920 may include an agent selection component 925, a testing scenario generation component 930, a training data generation component 935, an agent training component 940, an agent execution component 945, or any combination thereof. In some examples, the data generation module 920, or various components thereof, may be configured to perform various operations (e.g., receiving, monitoring, transmitting) using or otherwise in cooperation with the input module 910, the output module 915, or both. For example, the data generation module 920 may receive information from the input module 910, send information to the output module 915, or be integrated in combination with the input module 910, the output module 915, or both to receive information, transmit information, or perform various other operations as described herein.

The data generation module 920 may support agent testing generation via a LLM in accordance with examples as disclosed herein. The agent selection component 925 may be configured to support receiving, from a first user via a first user interface, a selection of one or more agents of a set of multiple agents to perform a first task, the set of multiple agents being associated with one or more AI/ML models to execute natural language queries, where each agent is associated with a set of parameters for performing one or more actions via the one or more AI/ML models. The testing scenario generation component 930 may be configured to support generating, via the LLM, a set of multiple scenarios for testing the one or more agents, the set of multiple scenarios corresponding to the one or more actions each agent of the one or more agents is instructed to perform based on the set of parameters of each agent. The training data generation component 935 may be configured to support generating, via the LLM and based on generation of the set of multiple scenarios, a set of training data for training the one or more agents to perform the first task, the set of training data being based on the set of parameters of the one or more agents and the set of multiple scenarios. The agent training component 940 may be configured to support training the one or more AI/ML models associated with the one or more agents using the set of training data generated via the LLM. The agent execution component 945 may be configured to support executing the one or more agents to perform the first task based on training the one or more AI/ML models associated with the one or more agents.

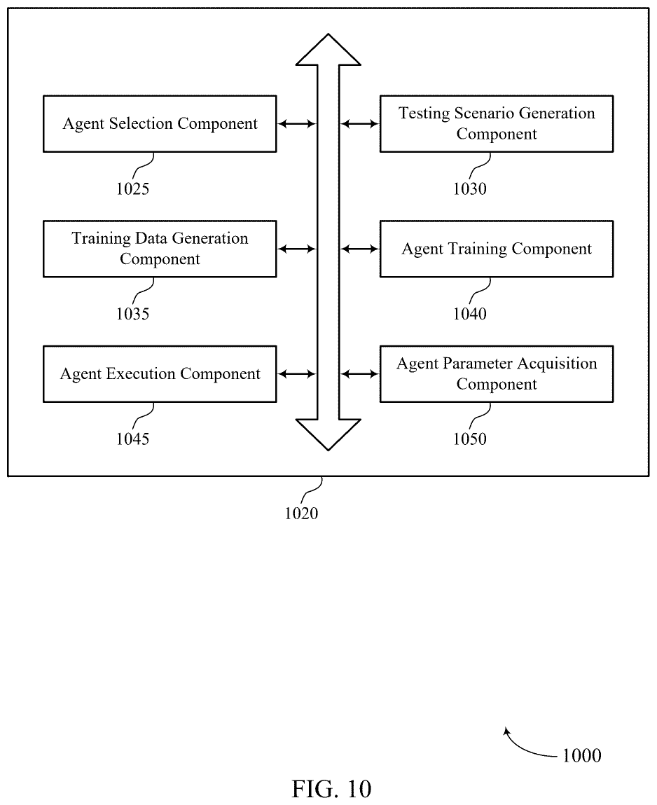

FIG. 10 shows a block diagram 1000 of a data generation module 1020 that supports automated agent testing and evaluation using LLMs in accordance with aspects of the present disclosure. The data generation module 1020 may be an example of aspects of a data generation module or a data generation module 920, or both, as described herein. The data generation module 1020, or various components thereof, may be an example of means for performing various aspects of automated agent testing and evaluation using LLMs as described herein. For example, the data generation module 1020 may include an agent selection component 1025, a testing scenario generation component 1030, a training data generation component 1035, an agent training component 1040, an agent execution component 1045, an agent parameter acquisition component 1050, or any combination thereof. Each of these components, or components of subcomponents thereof (e.g., one or more processors, one or more memories), may communicate, directly or indirectly, with one another (e.g., via one or more buses).

The data generation module 1020 may support agent testing generation via a LLM in accordance with examples as disclosed herein. The agent selection component 1025 may be configured to support receiving, from a first user via a first user interface, a selection of one or more agents of a set of multiple agents to perform a first task, the set of multiple agents being associated with one or more AI/ML models to execute natural language queries, where each agent is associated with a set of parameters for performing one or more actions via the one or more AI/ML models. The testing scenario generation component 1030 may be configured to support generating, via the LLM, a set of multiple scenarios for testing the one or more agents, the set of multiple scenarios corresponding to the one or more actions each agent of the one or more agents is instructed to perform based on the set of parameters of each agent. The training data generation component 1035 may be configured to support generating, via the LLM and based on generation of the set of multiple scenarios, a set of training data for training the one or more agents to perform the first task, the set of training data being based on the set of parameters of the one or more agents and the set of multiple scenarios. The agent training component 1040 may be configured to support training the one or more AI/ML models associated with the one or more agents using the set of training data generated via the LLM. The agent execution component 1045 may be configured to support executing the one or more agents to perform the first task based on training the one or more AI/ML models associated with the one or more agents.

In some examples, the agent parameter acquisition component 1050 may be configured to support obtaining, in response to receiving the selection of the one or more agents, the set of parameters for each agent of the one or more agents, where generating the set of multiple scenarios is based on obtaining the set of parameters for the one or more agents.

In some examples, to support receiving the selection of the one or more agents, the agent selection component 1025 may be configured to support receiving, via the selection of the one or more agents, an indication of the first task for the one or more agents to perform, where executing the one or more agents to perform the first task is based on receiving the indication of the first task.

In some examples, to support training the one or more agents, the agent training component 1040 may be configured to support obtaining, from the one or more AI/ML models associated with the one or more agents, a set of output data in response to the set of training data being provided as input to the one or more AI/ML models, the set of output data being associated with the first task. In some examples, to support training the one or more agents, the agent training component 1040 may be configured to support evaluating the set of output data to obtain a performance metric indication of the one or more agents.

In some examples, the set of output data is evaluated via code-based testing, via the LLM, via user feedback, or any combination thereof.

In some examples, the one or more agents are executed sequentially to perform the first task.

FIG. 11 shows a diagram of a system 1100 including a device 1105 that supports automated agent testing and evaluation using LLMs in accordance with aspects of the present disclosure. The device 1105 may be an example of or include components of a device 905 as described herein. The device 1105 may include components for bi-directional data communications including components for transmitting and receiving communications, such as a data generation module 1120, an I/O controller, such as an I/O controller 1110, a database controller 1115, at least one memory 1125, at least one processor 1130, and a database 1135. These components may be in electronic communication or otherwise coupled (e.g., operatively, communicatively, functionally, electronically, electrically) via one or more buses (e.g., a bus 1140).

The I/O controller 1110 may manage input signals 1145 and output signals 1150 for the device 1105. The I/O controller 1110 may also manage peripherals not integrated into the device 1105. In some cases, the I/O controller 1110 may represent a physical connection or port to an external peripheral. In some cases, the I/O controller 1110 may utilize an operating system such as iOS®, ANDROID®, MS-DOS®, MS-WINDOWS®, OS/2®, UNIX®, LINUX®, or another known operating system. In other cases, the I/O controller 1110 may represent or interact with a modem, a keyboard, a mouse, a touchscreen, or a similar device. In some cases, the I/O controller 1110 may be implemented as part of a processor 1130. In some examples, a user may interact with the device 1105 via the I/O controller 1110 or via hardware components controlled by the I/O controller 1110.

The database controller 1115 may manage data storage and processing in a database 1135. In some cases, a user may interact with the database controller 1115. In other cases, the database controller 1115 may operate automatically without user interaction. The database 1135 may be an example of a single database, a distributed database, multiple distributed databases, a data store, a data lake, or an emergency backup database.

Memory 1125 may include random-access memory (RAM) and read-only memory (ROM). The memory 1125 may store computer-readable, computer-executable software including instructions that, when executed, cause at least one processor 1130 to perform various functions described herein. In some cases, the memory 1125 may contain, among other things, a basic I/O system (BIOS) which may control basic hardware or software operation such as the interaction with peripheral components or devices. The memory 1125 may be an example of a single memory or multiple memories. For example, the device 1105 may include one or more memories 1125.

The processor 1130 may include an intelligent hardware device (e.g., a general-purpose processor, a digital signal processor (DSP), a central processing unit (CPU), a microcontroller, an application-specific integrated circuit (ASIC), a field-programmable gate array (FPGA), a programmable logic device, a discrete gate or transistor logic component, a discrete hardware component, or any combination thereof). In some cases, the processor 1130 may be configured to operate a memory array using a memory controller. In other cases, a memory controller may be integrated into the processor 1130. The processor 1130 may be configured to execute computer-readable instructions stored in at least one memory 1125 to perform various functions (e.g., functions or tasks supporting automated agent testing and evaluation using LLMs). The processor 1130 may be an example of a single processor or multiple processors. For example, the device 1105 may include one or more processors 1130.

The data generation module 1120 may support agent testing generation via a LLM in accordance with examples as disclosed herein. For example, the data generation module 1120 may be configured to support receiving, from a first user via a first user interface, a selection of one or more agents of a set of multiple agents to perform a first task, the set of multiple agents being associated with one or more AI/ML models to execute natural language queries, where each agent is associated with a set of parameters for performing one or more actions via the one or more AI/ML models. The data generation module 1120 may be configured to support generating, via the LLM, a set of multiple scenarios for testing the one or more agents, the set of multiple scenarios corresponding to the one or more actions each agent of the one or more agents is instructed to perform based on the set of parameters of each agent. The data generation module 1120 may be configured to support generating, via the LLM and based on generation of the set of multiple scenarios, a set of training data for training the one or more agents to perform the first task, the set of training data being based on the set of parameters of the one or more agents and the set of multiple scenarios. The data generation module 1120 may be configured to support training the one or more AI/ML models associated with the one or more agents using the set of training data generated via the LLM. The data generation module 1120 may be configured to support executing the one or more agents to perform the first task based on training the one or more AI/ML models associated with the one or more agents.

By including or configuring the data generation module 1120 in accordance with examples as described herein, the device 1105 may support techniques for testing and training agents to support improved testing of agents to execute tasks where agents interact with other agents, improved coordination between agents, more efficient utilization of computational and time resources, and reduced complexity for training various agents to perform tasks.

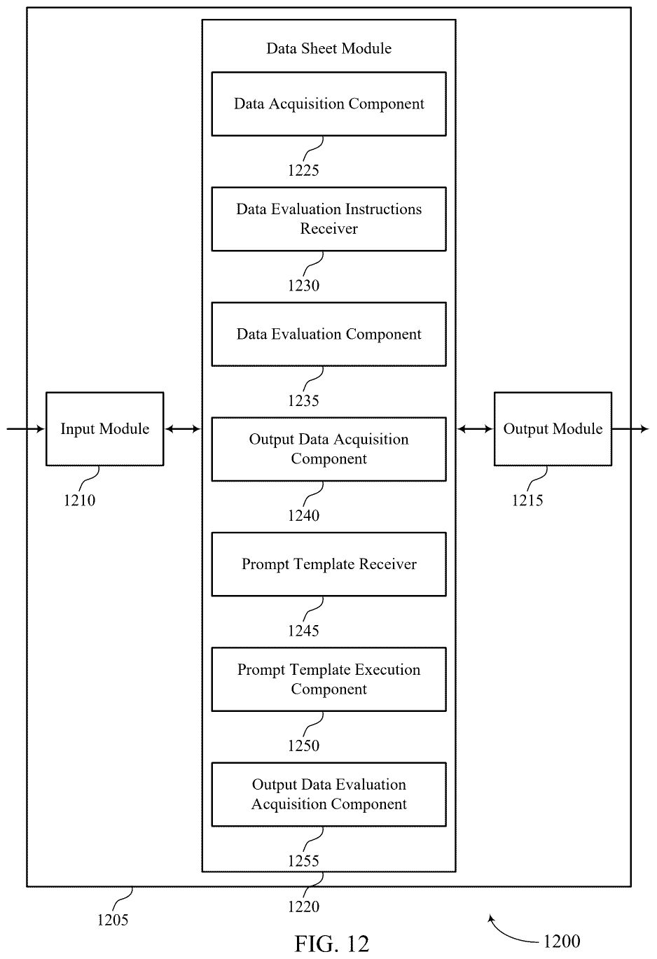

FIG. 12 shows a block diagram 1200 of a device 1205 that supports automated agent testing and evaluation using LLMs in accordance with aspects of the present disclosure. The device 1205 may include an input module 1210, an output module 1215, and a data sheet module 1220. The device 1205, or one or more components of the device 1205 (e.g., the input module 1210, the output module 1215, the data sheet module 1220), may include at least one processor, which may be coupled with at least one memory, to support the described techniques. Each of these components may be in communication with one another (e.g., via one or more buses).

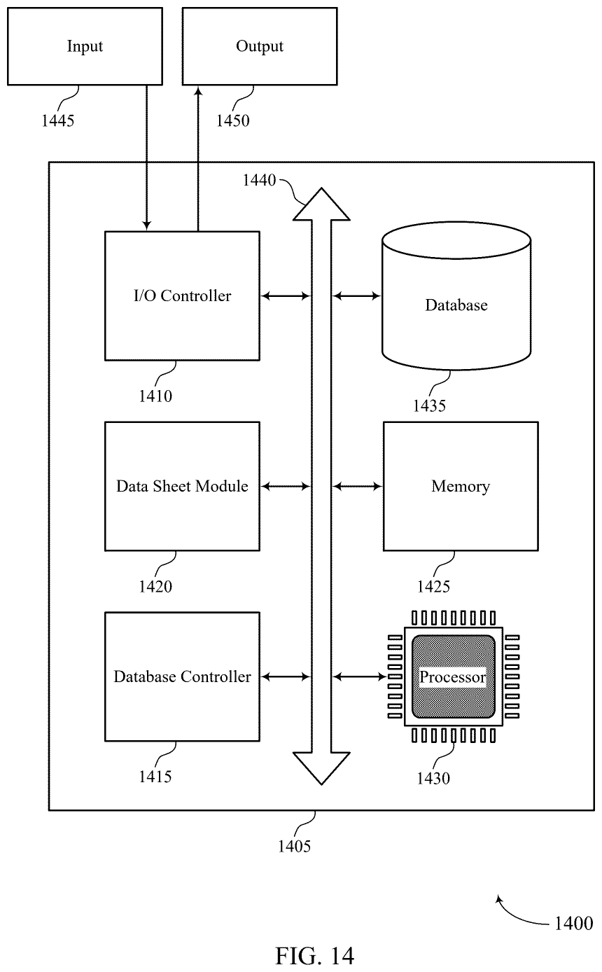

The input module 1210 may manage input signals for the device 1205. For example, the input module 1210 may identify input signals based on an interaction with a modem, a keyboard, a mouse, a touchscreen, or a similar device. These input signals may be associated with user input or processing at other components or devices. In some cases, the input module 1210 may utilize an operating system such as iOS®, ANDROID®, MS-DOS®, MS-WINDOWS®, OS/2®, UNIX®, LINUX®, or another known operating system to handle input signals. The input module 1210 may send aspects of these input signals to other components of the device 1205 for processing. For example, the input module 1210 may transmit input signals to the data sheet module 1220 to support automated agent testing and evaluation using LLMs. In some cases, the input module 1210 may be a component of an input/output (I/O) controller 1410 as described with reference to FIG. 14.

The output module 1215 may manage output signals for the device 1205. For example, the output module 1215 may receive signals from other components of the device 1205, such as the data sheet module 1220, and may transmit these signals to other components or devices. In some examples, the output module 1215 may transmit output signals for display in a user interface, for storage in a database or data store, for further processing at a server or server cluster, or for any other processes at any number of devices or systems. In some cases, the output module 1215 may be a component of an I/O controller 1410 as described with reference to FIG. 14.

For example, the data sheet module 1220 may include a data acquisition component 1225, a data evaluation instructions receiver 1230, a data evaluation component 1235, an output data acquisition component 1240, a prompt template receiver 1245, a prompt template execution component 1250, an output data evaluation acquisition component 1255, or any combination thereof. In some examples, the data sheet module 1220, or various components thereof, may be configured to perform various operations (e.g., receiving, monitoring, transmitting) using or otherwise in cooperation with the input module 1210, the output module 1215, or both. For example, the data sheet module 1220 may receive information from the input module 1210, send information to the output module 1215, or be integrated in combination with the input module 1210, the output module 1215, or both to receive information, transmit information, or perform various other operations as described herein.

The data sheet module 1220 may support data evaluation via LLMs (LLMs) in accordance with examples as disclosed herein. The data acquisition component 1225 may be configured to support obtaining, via a first user interface, a set of data within an interactive data table, the interactive data table including a set of multiple fields and the set of multiple fields including a set of multiple data records from the set of data. The data evaluation instructions receiver 1230 may be configured to support receiving a set of instructions for evaluation of the set of data within the interactive data table by an LLM, the set of instructions including an indication of one or more fields of the set of multiple fields and an output format. The data evaluation component 1235 may be configured to support evaluating, via the LLM and in accordance with the set of instructions for the evaluation, a subset of data of the set of data within the interactive data table, the subset of data being associated with the one or more fields of the interactive data table indicated via the set of instructions. The output data acquisition component 1240 may be configured to support obtaining, from the LLM and based on the evaluation, a set of output data within the output format indicated via the set of instructions for the evaluation.

Additionally, or alternatively, the data sheet module 1220 may support LLM prompt evaluation in accordance with examples as disclosed herein. The data acquisition component 1225 may be configured to support obtaining, via a first user interface, a set of data within an interactive data table, the interactive data table including a set of multiple fields and the set of multiple fields including a set of multiple data records from the set of data. The prompt template receiver 1245 may be configured to support receiving a prompt template for an LLM that is associated with evaluation of the set of data obtained via the first user interface, the prompt template including a set of instructions for the LLM to evaluate the set of data, where the set of instructions includes an indication of one or more fields of the set of multiple fields of the interactive data table. The prompt template execution component 1250 may be configured to support executing, via the LLM and based on receiving the prompt template, the set of instructions of the prompt template using the set of data of within the interactive data table to obtain a set of output data. The output data evaluation acquisition component 1255 may be configured to support evaluating, via the LLM and in response to executing the prompt template, the set of output data according to obtain one or more indications of a performance of the prompt template.

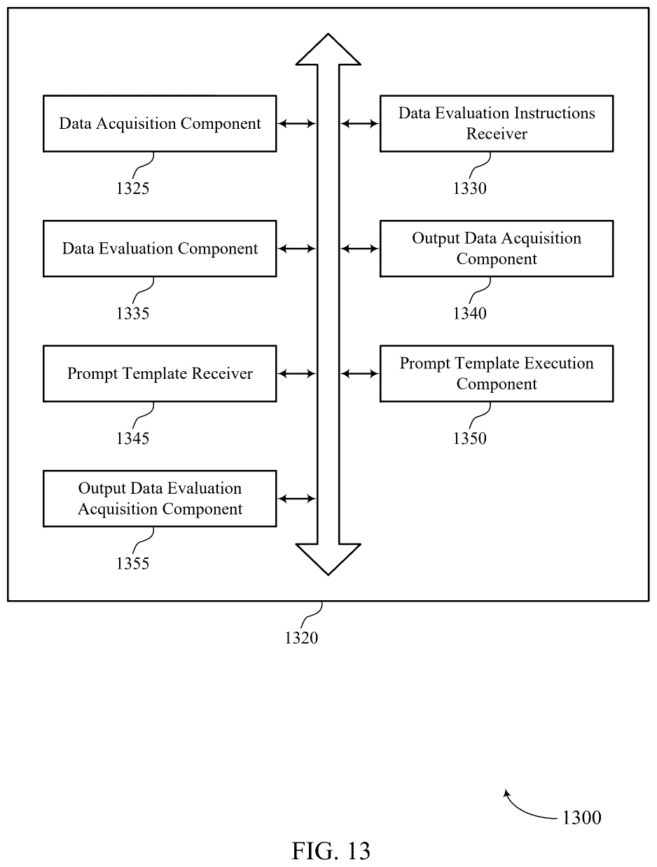

FIG. 13 shows a block diagram 1300 of a data sheet module 1320 that supports automated agent testing and evaluation using LLMs in accordance with aspects of the present disclosure. The data sheet module 1320 may be an example of aspects of a data sheet module or a data sheet module 1220, or both, as described herein. The data sheet module 1320, or various components thereof, may be an example of means for performing various aspects of automated agent testing and evaluation using LLMs as described herein. For example, the data sheet module 1320 may include a data acquisition component 1325, a data evaluation instructions receiver 1330, a data evaluation component 1335, an output data acquisition component 1340, a prompt template receiver 1345, a prompt template execution component 1350, an output data evaluation acquisition component 1355, or any combination thereof. Each of these components, or components of subcomponents thereof (e.g., one or more processors, one or more memories), may communicate, directly or indirectly, with one another (e.g., via one or more buses).

The data sheet module 1320 may support data evaluation via LLMs (LLMs) in accordance with examples as disclosed herein. The data acquisition component 1325 may be configured to support obtaining, via a first user interface, a set of data within an interactive data table, the interactive data table including a set of multiple fields and the set of multiple fields including a set of multiple data records from the set of data. The data evaluation instructions receiver 1330 may be configured to support receiving a set of instructions for evaluation of the set of data within the interactive data table by an LLM, the set of instructions including an indication of one or more fields of the set of multiple fields and an output format. The data evaluation component 1335 may be configured to support evaluating, via the LLM and in accordance with the set of instructions for the evaluation, a subset of data of the set of data within the interactive data table, the subset of data being associated with the one or more fields of the interactive data table indicated via the set of instructions. The output data acquisition component 1340 may be configured to support obtaining, from the LLM and based on the evaluation, a set of output data within the output format indicated via the set of instructions for the evaluation.

In some examples, the output data evaluation acquisition component 1355 may be configured to support obtaining, from one or more user inputs or from the LLM, an evaluation of the set of output data based on the set of output data from the LLM.

In some examples, to support obtaining the set of output data, the output data acquisition component 1340 may be configured to support displaying, via the first user interface, the set of output data within an output field of the set of multiple fields of the interactive data table.

In some examples, to support obtaining the set of data, the output data acquisition component 1340 may be configured to support obtaining, via the first user interface, the set of data from a first user, from the LLM, or both.

In some examples, to support obtaining the set of data from the first user, the output data acquisition component 1340 may be configured to support obtaining, from the first user and via the first user interface, the set of data via one or more user inputs including the set of data, via an indication of a file including the set of data, or a combination thereof.

In some examples, to support obtaining the set of data from the LLM, the output data acquisition component 1340 may be configured to support transmitting, to the LLM, a query to generate the set of data, the query including one or more LLM prompt parameters for the LLM to utilize to generate the set of data.

In some examples, the set of data includes text data, a single select data, multi-select data, numerical data, currency data, percentage data, one or more attachments, one or more formulas, record data, one or more images, audio data, or any combination thereof.

In some examples, the set of output data includes textual data, numerical data, single tag data, multiple tag data, currency data, percentage data, or any combination thereof based on the output format indicated via the set of instructions for the evaluation of the set of data.

In some examples, the set of multiple fields of the interactive data table are associated with a set of columns of the interactive data table.

Additionally, or alternatively, the data sheet module 1320 may support LLM prompt evaluation in accordance with examples as disclosed herein. In some examples, the data acquisition component 1325 may be configured to support obtaining, via a first user interface, a set of data within an interactive data table, the interactive data table including a set of multiple fields and the set of multiple fields including a set of multiple data records from the set of data. The prompt template receiver 1345 may be configured to support receiving a prompt template for an LLM that is associated with evaluation of the set of data obtained via the first user interface, the prompt template including a set of instructions for the LLM to evaluate the set of data, where the set of instructions includes an indication of one or more fields of the set of multiple fields of the interactive data table. The prompt template execution component 1350 may be configured to support executing, via the LLM and based on receiving the prompt template, the set of instructions of the prompt template using the set of data of within the interactive data table to obtain a set of output data. The output data evaluation acquisition component 1355 may be configured to support evaluating, via the LLM and in response to executing the prompt template, the set of output data according to obtain one or more indications of a performance of the prompt template.

In some examples, the one or more indications of the performance of the prompt template include a coherency indication, a relevance indication, an accuracy indication, or any combination thereof.

In some examples, to support executing the set of instructions of the prompt template, the prompt template execution component 1350 may be configured to support obtaining, from the set of data within the interactive data table, a subset of data associated with the one or more fields indicated via the set of instructions. In some examples, to support executing the set of instructions of the prompt template, the prompt template execution component 1350 may be configured to support transmitting, to the LLM, the set of instructions of the prompt template with the subset of data included within the set of instructions in place of the indication of the one or more fields, where the set of output data is obtained based on the subset of data being included within the set of instructions.

In some examples, to support executing the set of instructions of the prompt template, the prompt template execution component 1350 may be configured to support displaying, via the first user interface, the set of output data within an output field of the set of multiple fields of the interactive data table.

In some examples, the set of data includes text data, a single select data, multi-select data, numerical data, currency data, percentage data, one or more attachments, one or more formulas, record data, one or more images, audio data, or any combination thereof.

FIG. 14 shows a diagram of a system 1400 including a device 1405 that supports automated agent testing and evaluation using LLMs in accordance with aspects of the present disclosure. The device 1405 may be an example of or include components of a device 1205 as described herein. The device 1405 may include components for bi-directional data communications including components for transmitting and receiving communications, such as a data sheet module 1420, an I/O controller, such as an I/O controller 1410, a database controller 1415, at least one memory 1425, at least one processor 1430, and a database 1435. These components may be in electronic communication or otherwise coupled (e.g., operatively, communicatively, functionally, electronically, electrically) via one or more buses (e.g., a bus 1440).

The I/O controller 1410 may manage input signals 1445 and output signals 1450 for the device 1405. The I/O controller 1410 may also manage peripherals not integrated into the device 1405. In some cases, the I/O controller 1410 may represent a physical connection or port to an external peripheral. In some cases, the I/O controller 1410 may utilize an operating system such as iOS®, ANDROID®, MS-DOS®, MS-WINDOWS®, OS/2®, UNIX®, LINUX®, or another known operating system. In other cases, the I/O controller 1410 may represent or interact with a modem, a keyboard, a mouse, a touchscreen, or a similar device. In some cases, the I/O controller 1410 may be implemented as part of a processor 1430. In some examples, a user may interact with the device 1405 via the I/O controller 1410 or via hardware components controlled by the I/O controller 1410.

The database controller 1415 may manage data storage and processing in a database 1435. In some cases, a user may interact with the database controller 1415. In other cases, the database controller 1415 may operate automatically without user interaction. The database 1435 may be an example of a single database, a distributed database, multiple distributed databases, a data store, a data lake, or an emergency backup database.

Memory 1425 may include random-access memory (RAM) and read-only memory (ROM). The memory 1425 may store computer-readable, computer-executable software including instructions that, when executed, cause at least one processor 1430 to perform various functions described herein. In some cases, the memory 1425 may contain, among other things, a basic I/O system (BIOS) which may control basic hardware or software operation such as the interaction with peripheral components or devices. The memory 1425 may be an example of a single memory or multiple memories. For example, the device 1405 may include one or more memories 1425.

The processor 1430 may include an intelligent hardware device (e.g., a general-purpose processor, a digital signal processor (DSP), a central processing unit (CPU), a microcontroller, an application-specific integrated circuit (ASIC), a field-programmable gate array (FPGA), a programmable logic device, a discrete gate or transistor logic component, a discrete hardware component, or any combination thereof). In some cases, the processor 1430 may be configured to operate a memory array using a memory controller. In other cases, a memory controller may be integrated into the processor 1430. The processor 1430 may be configured to execute computer-readable instructions stored in at least one memory 1425 to perform various functions (e.g., functions or tasks supporting automated agent testing and evaluation using LLMs). The processor 1430 may be an example of a single processor or multiple processors. For example, the device 1405 may include one or more processors 1430.

The data sheet module 1420 may support data evaluation via LLMs (LLMs) in accordance with examples as disclosed herein. For example, the data sheet module 1420 may be configured to support obtaining, via a first user interface, a set of data within an interactive data table, the interactive data table including a set of multiple fields and the set of multiple fields including a set of multiple data records from the set of data. The data sheet module 1420 may be configured to support receiving a set of instructions for evaluation of the set of data within the interactive data table by an LLM, the set of instructions including an indication of one or more fields of the set of multiple fields and an output format. The data sheet module 1420 may be configured to support evaluating, via the LLM and in accordance with the set of instructions for the evaluation, a subset of data of the set of data within the interactive data table, the subset of data being associated with the one or more fields of the interactive data table indicated via the set of instructions. The data sheet module 1420 may be configured to support obtaining, from the LLM and based on the evaluation, a set of output data within the output format indicated via the set of instructions for the evaluation.

Additionally, or alternatively, the data sheet module 1420 may support LLM prompt evaluation in accordance with examples as disclosed herein. For example, the data sheet module 1420 may be configured to support obtaining, via a first user interface, a set of data within an interactive data table, the interactive data table including a set of multiple fields and the set of multiple fields including a set of multiple data records from the set of data. The data sheet module 1420 may be configured to support receiving a prompt template for an LLM that is associated with evaluation of the set of data obtained via the first user interface, the prompt template including a set of instructions for the LLM to evaluate the set of data, where the set of instructions includes an indication of one or more fields of the set of multiple fields of the interactive data table. The data sheet module 1420 may be configured to support executing, via the LLM and based on receiving the prompt template, the set of instructions of the prompt template using the set of data of within the interactive data table to obtain a set of output data. The data sheet module 1420 may be configured to support evaluating, via the LLM and in response to executing the prompt template, the set of output data according to obtain one or more indications of a performance of the prompt template.

By including or configuring the data sheet module 1420 in accordance with examples as described herein, the device 1405 may support techniques for data evaluation and LLM prompt evaluation to support improved function of data tables, improved accuracy of LLM generations, and improved efficiency for data input, data evaluation, and for prompt template evaluations.

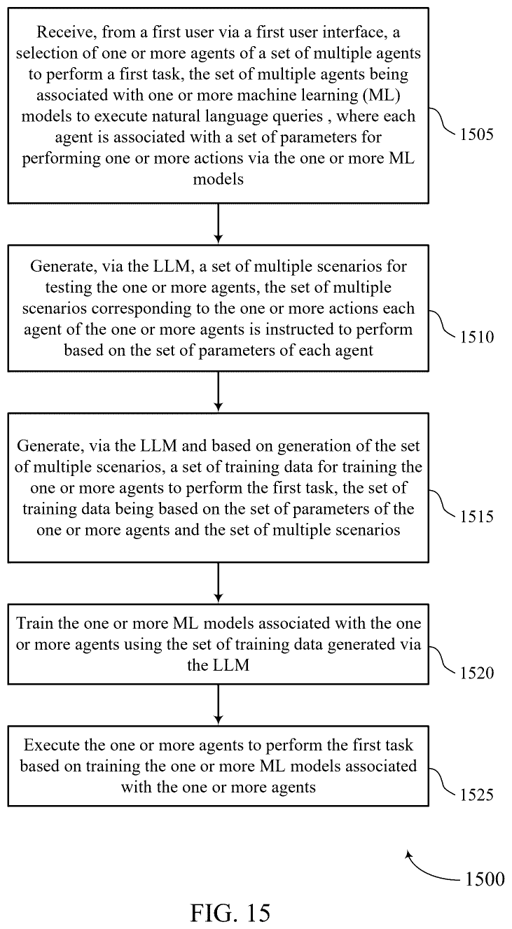

FIG. 15 shows a flowchart illustrating a method 1500 that supports automated agent testing and evaluation using LLMs in accordance with aspects of the present disclosure. The operations of the method 1500 may be implemented by an agent training service or its components as described herein. For example, the operations of the method 1500 may be performed by an agent training service as described with reference to FIGS. 1 through 11. In some examples, an agent training service may execute a set of instructions to control the functional elements of the agent training service to perform the described functions. Additionally, or alternatively, the agent training service may perform aspects of the described functions using special-purpose hardware.

At 1505, the method may include receiving, from a first user via a first user interface, a selection of one or more agents of a set of multiple agents to perform a first task, the set of multiple agents being associated with one or more AI/ML models to execute natural language queries, where each agent is associated with a set of parameters for performing one or more actions via the one or more AI/ML models. The operations of 1505 may be performed in accordance with examples as disclosed herein. In some examples, aspects of the operations of 1505 may be performed by an agent selection component 1025 as described with reference to FIG. 10.

At 1510, the method may include generating, via the LLM, a set of multiple scenarios for testing the one or more agents, the set of multiple scenarios corresponding to the one or more actions each agent of the one or more agents is instructed to perform based on the set of parameters of each agent. The operations of 1510 may be performed in accordance with examples as disclosed herein. In some examples, aspects of the operations of 1510 may be performed by a testing scenario generation component 1030 as described with reference to FIG. 10.

At 1515, the method may include generating, via the LLM and based on generation of the set of multiple scenarios, a set of training data for training the one or more agents to perform the first task, the set of training data being based on the set of parameters of the one or more agents and the set of multiple scenarios. The operations of 1515 may be performed in accordance with examples as disclosed herein. In some examples, aspects of the operations of 1515 may be performed by a training data generation component 1035 as described with reference to FIG. 10.

At 1520, the method may include training the one or more AI/ML models associated with the one or more agents using the set of training data generated via the LLM. The operations of 1520 may be performed in accordance with examples as disclosed herein. In some examples, aspects of the operations of 1520 may be performed by an agent training component 1040 as described with reference to FIG. 10.

At 1525, the method may include executing the one or more agents to perform the first task based on training the one or more AI/ML models associated with the one or more agents. The operations of 1525 may be performed in accordance with examples as disclosed herein. In some examples, aspects of the operations of 1525 may be performed by an agent execution component 1045 as described with reference to FIG. 10.

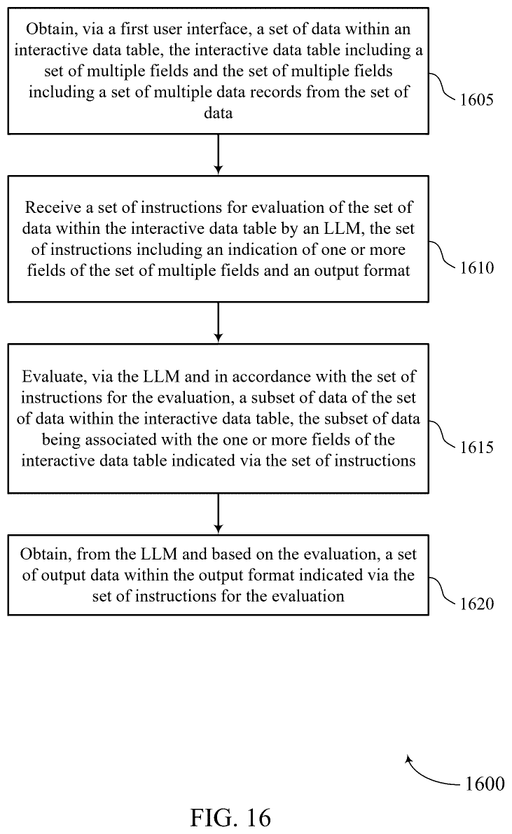

FIG. 16 shows a flowchart illustrating a method 1600 that supports automated agent testing and evaluation using LLMs in accordance with aspects of the present disclosure. The operations of the method 1600 may be implemented by an LLM service or its components as described herein. For example, the operations of the method 1600 may be performed by an LLM service as described with reference to FIGS. 1 through 8 and 12 through 14. In some examples, an LLM service may execute a set of instructions to control the functional elements of the LLM service to perform the described functions. Additionally, or alternatively, the LLM service may perform aspects of the described functions using special-purpose hardware.

At 1605, the method may include obtaining, via a first user interface, a set of data within an interactive data table, the interactive data table including a set of multiple fields and the set of multiple fields including a set of multiple data records from the set of data. The operations of 1605 may be performed in accordance with examples as disclosed herein. In some examples, aspects of the operations of 1605 may be performed by a data acquisition component 1325 as described with reference to FIG. 13.

At 1610, the method may include receiving a set of instructions for evaluation of the set of data within the interactive data table by an LLM, the set of instructions including an indication of one or more fields of the set of multiple fields and an output format. The operations of 1610 may be performed in accordance with examples as disclosed herein. In some examples, aspects of the operations of 1610 may be performed by a data evaluation instructions receiver 1330 as described with reference to FIG. 13.

At 1615, the method may include evaluating, via the LLM and in accordance with the set of instructions for the evaluation, a subset of data of the set of data within the interactive data table, the subset of data being associated with the one or more fields of the interactive data table indicated via the set of instructions. The operations of 1615 may be performed in accordance with examples as disclosed herein. In some examples, aspects of the operations of 1615 may be performed by a data evaluation component 1335 as described with reference to FIG. 13.

At 1620, the method may include obtaining, from the LLM and based on the evaluation, a set of output data within the output format indicated via the set of instructions for the evaluation. The operations of 1620 may be performed in accordance with examples as disclosed herein. In some examples, aspects of the operations of 1620 may be performed by an output data acquisition component 1340 as described with reference to FIG. 13.

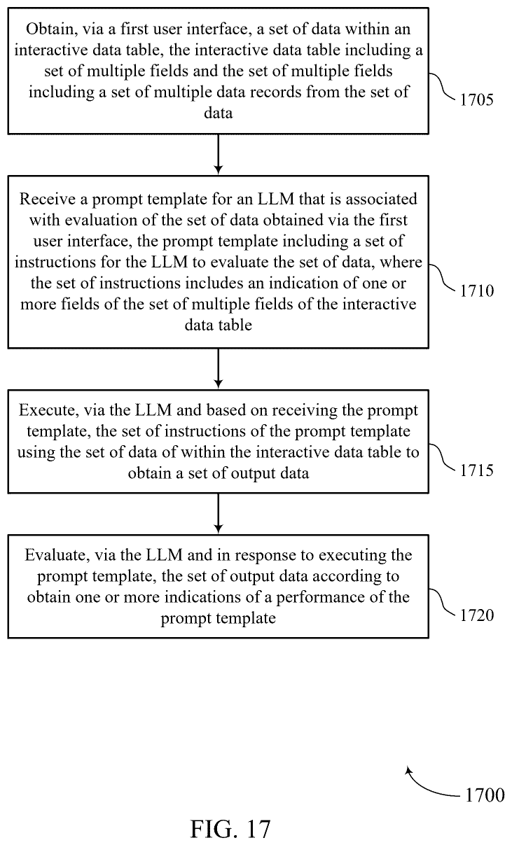

FIG. 17 shows a flowchart illustrating a method 1700 that supports automated agent testing and evaluation using LLMs in accordance with aspects of the present disclosure. The operations of the method 1700 may be implemented by an LLM service or its components as described herein. For example, the operations of the method 1700 may be performed by an LLM service as described with reference to FIGS. 1 through 8 and 12 through 14. In some examples, an LLM service may execute a set of instructions to control the functional elements of the LLM service to perform the described functions. Additionally, or alternatively, the LLM service may perform aspects of the described functions using special-purpose hardware.

At 1705, the method may include obtaining, via a first user interface, a set of data within an interactive data table, the interactive data table including a set of multiple fields and the set of multiple fields including a set of multiple data records from the set of data. The operations of 1705 may be performed in accordance with examples as disclosed herein. In some examples, aspects of the operations of 1705 may be performed by a data acquisition component 1325 as described with reference to FIG. 13.

At 1710, the method may include receiving a prompt template for an LLM that is associated with evaluation of the set of data obtained via the first user interface, the prompt template including a set of instructions for the LLM to evaluate the set of data, where the set of instructions includes an indication of one or more fields of the set of multiple fields of the interactive data table. The operations of 1710 may be performed in accordance with examples as disclosed herein. In some examples, aspects of the operations of 1710 may be performed by a prompt template receiver 1345 as described with reference to FIG. 13.

At 1715, the method may include executing, via the LLM and based on receiving the prompt template, the set of instructions of the prompt template using the set of data of within the interactive data table to obtain a set of output data. The operations of 1715 may be performed in accordance with examples as disclosed herein. In some examples, aspects of the operations of 1715 may be performed by a prompt template execution component 1350 as described with reference to FIG. 13.

At 1720, the method may include evaluating, via the LLM and in response to executing the prompt template, the set of output data according to obtain one or more indications of a performance of the prompt template. The operations of 1720 may be performed in accordance with examples as disclosed herein. In some examples, aspects of the operations of 1720 may be performed by an output data evaluation acquisition component 1355 as described with reference to FIG. 13.

A method for agent testing generation via a LLM by an apparatus is described. The method may include receiving, from a first user via a first user interface, a selection of one or more agents of a set of multiple agents to perform a first task, the set of multiple agents being associated with one or more AI/ML models to execute natural language queries, where each agent is associated with a set of parameters for performing one or more actions via the one or more AI/ML models, generating, via the LLM, a set of multiple scenarios for testing the one or more agents, the set of multiple scenarios corresponding to the one or more actions each agent of the one or more agents is instructed to perform based on the set of parameters of each agent, generating, via the LLM and based on generation of the set of multiple scenarios, a set of training data for training the one or more agents to perform the first task, the set of training data being based on the set of parameters of the one or more agents and the set of multiple scenarios, training the one or more AI/ML models associated with the one or more agents using the set of training data generated via the LLM, and executing the one or more agents to perform the first task based on training the one or more AI/ML models associated with the one or more agents.

An apparatus for agent testing generation via a LLM is described. The apparatus may include one or more memories storing processor executable code, and one or more processors coupled with the one or more memories. The one or more processors may individually or collectively be operable to execute the code to cause the apparatus to receive, from a first user via a first user interface, a selection of one or more agents of a set of multiple agents to perform a first task, the set of multiple agents being associated with one or more AI/ML models to execute natural language queries, where each agent is associated with a set of parameters for performing one or more actions via the one or more AI/ML models, generate, via the LLM, a set of multiple scenarios for testing the one or more agents, the set of multiple scenarios corresponding to the one or more actions each agent of the one or more agents is instructed to perform based on the set of parameters of each agent, generate, via the LLM and based on generation of the set of multiple scenarios, a set of training data for training the one or more agents to perform the first task, the set of training data being based on the set of parameters of the one or more agents and the set of multiple scenarios, train the one or more AI/ML models associated with the one or more agents using the set of training data generated via the LLM, and execute the one or more agents to perform the first task based on training the one or more AI/ML models associated with the one or more agents.

Another apparatus for agent testing generation via a LLM is described. The apparatus may include means for receiving, from a first user via a first user interface, a selection of one or more agents of a set of multiple agents to perform a first task, the set of multiple agents being associated with one or more AI/ML models to execute natural language queries, where each agent is associated with a set of parameters for performing one or more actions via the one or more AI/ML models, means for generating, via the LLM, a set of multiple scenarios for testing the one or more agents, the set of multiple scenarios corresponding to the one or more actions each agent of the one or more agents is instructed to perform based on the set of parameters of each agent, means for generating, via the LLM and based on generation of the set of multiple scenarios, a set of training data for training the one or more agents to perform the first task, the set of training data being based on the set of parameters of the one or more agents and the set of multiple scenarios, means for training the one or more AI/ML models associated with the one or more agents using the set of training data generated via the LLM, and means for executing the one or more agents to perform the first task based on training the one or more AI/ML models associated with the one or more agents.

A non-transitory computer-readable medium storing code for agent testing generation via a LLM is described. The code may include instructions executable by one or more processors to receive, from a first user via a first user interface, a selection of one or more agents of a set of multiple agents to perform a first task, the set of multiple agents being associated with one or more AI/ML models to execute natural language queries, where each agent is associated with a set of parameters for performing one or more actions via the one or more AI/ML models, generate, via the LLM, a set of multiple scenarios for testing the one or more agents, the set of multiple scenarios corresponding to the one or more actions each agent of the one or more agents is instructed to perform based on the set of parameters of each agent, generate, via the LLM and based on generation of the set of multiple scenarios, a set of training data for training the one or more agents to perform the first task, the set of training data being based on the set of parameters of the one or more agents and the set of multiple scenarios, train the one or more AI/ML models associated with the one or more agents using the set of training data generated via the LLM, and execute the one or more agents to perform the first task based on training the one or more AI/ML models associated with the one or more agents.

Some examples of the method, apparatus, and non-transitory computer-readable medium described herein may further include operations, features, means, or instructions for obtaining, in response to receiving the selection of the one or more agents, the set of parameters for each agent of the one or more agents, where generating the set of multiple scenarios may be based on obtaining the set of parameters for the one or more agents.

In some examples of the method, apparatus, and non-transitory computer-readable medium described herein, receiving the selection of the one or more agents may include operations, features, means, or instructions for receiving, via the selection of the one or more agents, an indication of the first task for the one or more agents to perform, where executing the one or more agents to perform the first task may be based on receiving the indication of the first task.

In some examples of the method, apparatus, and non-transitory computer-readable medium described herein, training the one or more agents may include operations, features, means, or instructions for obtaining, from the one or more AI/ML models associated with the one or more agents, a set of output data in response to the set of training data being provided as input to the one or more AI/ML models, the set of output data being associated with the first task and evaluating the set of output data to obtain a performance metric indication of the one or more agents.

In some examples of the method, apparatus, and non-transitory computer-readable medium described herein, the set of output data may be evaluated via code-based testing, via the LLM, via user feedback, or any combination thereof.

In some examples of the method, apparatus, and non-transitory computer-readable medium described herein, the one or more agents may be executed sequentially to perform the first task.

A method for data evaluation via LLMs (LLMs) by an apparatus is described. The method may include obtaining, via a first user interface, a set of data within an interactive data table, the interactive data table including a set of multiple fields and the set of multiple fields including a set of multiple data records from the set of data, receiving a set of instructions for evaluation of the set of data within the interactive data table by an LLM, the set of instructions including an indication of one or more fields of the set of multiple fields and an output format, evaluating, via the LLM and in accordance with the set of instructions for the evaluation, a subset of data of the set of data within the interactive data table, the subset of data being associated with the one or more fields of the interactive data table indicated via the set of instructions, and obtaining, from the LLM and based on the evaluation, a set of output data within the output format indicated via the set of instructions for the evaluation.

An apparatus for data evaluation via LLMs (LLMs) is described. The apparatus may include one or more memories storing processor executable code, and one or more processors coupled with the one or more memories. The one or more processors may individually or collectively be operable to execute the code to cause the apparatus to obtain, via a first user interface, a set of data within an interactive data table, the interactive data table including a set of multiple fields and the set of multiple fields including a set of multiple data records from the set of data, receive a set of instructions for evaluation of the set of data within the interactive data table by an LLM, the set of instructions including an indication of one or more fields of the set of multiple fields and an output format, evaluate, via the LLM and in accordance with the set of instructions for the evaluation, a subset of data of the set of data within the interactive data table, the subset of data being associated with the one or more fields of the interactive data table indicated via the set of instructions, and obtain, from the LLM and based on the evaluation, a set of output data within the output format indicated via the set of instructions for the evaluation.

Another apparatus for data evaluation via LLMs (LLMs) is described. The apparatus may include means for obtaining, via a first user interface, a set of data within an interactive data table, the interactive data table including a set of multiple fields and the set of multiple fields including a set of multiple data records from the set of data, means for receiving a set of instructions for evaluation of the set of data within the interactive data table by an LLM, the set of instructions including an indication of one or more fields of the set of multiple fields and an output format, means for evaluating, via the LLM and in accordance with the set of instructions for the evaluation, a subset of data of the set of data within the interactive data table, the subset of data being associated with the one or more fields of the interactive data table indicated via the set of instructions, and means for obtaining, from the LLM and based on the evaluation, a set of output data within the output format indicated via the set of instructions for the evaluation.

A non-transitory computer-readable medium storing code for data evaluation via LLMs (LLMs) is described. The code may include instructions executable by one or more processors to obtain, via a first user interface, a set of data within an interactive data table, the interactive data table including a set of multiple fields and the set of multiple fields including a set of multiple data records from the set of data, receive a set of instructions for evaluation of the set of data within the interactive data table by an LLM, the set of instructions including an indication of one or more fields of the set of multiple fields and an output format, evaluate, via the LLM and in accordance with the set of instructions for the evaluation, a subset of data of the set of data within the interactive data table, the subset of data being associated with the one or more fields of the interactive data table indicated via the set of instructions, and obtain, from the LLM and based on the evaluation, a set of output data within the output format indicated via the set of instructions for the evaluation.

Some examples of the method, apparatus, and non-transitory computer-readable medium described herein may further include operations, features, means, or instructions for obtaining, from one or more user inputs or from the LLM, an evaluation of the set of output data based on the set of output data from the LLM.

In some examples of the method, apparatus, and non-transitory computer-readable medium described herein, obtaining the set of output data may include operations, features, means, or instructions for displaying, via the first user interface, the set of output data within an output field of the set of multiple fields of the interactive data table.

In some examples of the method, apparatus, and non-transitory computer-readable medium described herein, obtaining the set of data may include operations, features, means, or instructions for obtaining, via the first user interface, the set of data from a first user, from the LLM, or both.

In some examples of the method, apparatus, and non-transitory computer-readable medium described herein, obtaining the set of data from the first user may include operations, features, means, or instructions for obtaining, from the first user and via the first user interface, the set of data via one or more user inputs including the set of data, via an indication of a file including the set of data, or a combination thereof.

In some examples of the method, apparatus, and non-transitory computer-readable medium described herein, obtaining the set of data from the LLM may include operations, features, means, or instructions for transmitting, to the LLM, a query to generate the set of data, the query including one or more LLM prompt parameters for the LLM to utilize to generate the set of data.

In some examples of the method, apparatus, and non-transitory computer-readable medium described herein, the set of data includes text data, a single select data, multi-select data, numerical data, currency data, percentage data, one or more attachments, one or more formulas, record data, one or more images, audio data, or any combination thereof.

In some examples of the method, apparatus, and non-transitory computer-readable medium described herein, the set of output data includes textual data, numerical data, single tag data, multiple tag data, currency data, percentage data, or any combination thereof based on the output format indicated via the set of instructions for the evaluation of the set of data.

In some examples of the method, apparatus, and non-transitory computer-readable medium described herein, the set of multiple fields of the interactive data table may be associated with a set of columns of the interactive data table.

A method for LLM prompt evaluation by an apparatus is described. The method may include obtaining, via a first user interface, a set of data within an interactive data table, the interactive data table including a set of multiple fields and the set of multiple fields including a set of multiple data records from the set of data, receiving a prompt template for an LLM that is associated with evaluation of the set of data obtained via the first user interface, the prompt template including a set of instructions for the LLM to evaluate the set of data, where the set of instructions includes an indication of one or more fields of the set of multiple fields of the interactive data table, executing, via the LLM and based on receiving the prompt template, the set of instructions of the prompt template using the set of data of within the interactive data table to obtain a set of output data, and evaluating, via the LLM and in response to executing the prompt template, the set of output data according to obtain one or more indications of a performance of the prompt template.

An apparatus for LLM prompt evaluation is described. The apparatus may include one or more memories storing processor executable code, and one or more processors coupled with the one or more memories. The one or more processors may individually or collectively be operable to execute the code to cause the apparatus to obtain, via a first user interface, a set of data within an interactive data table, the interactive data table including a set of multiple fields and the set of multiple fields including a set of multiple data records from the set of data, receive a prompt template for an LLM that is associated with evaluation of the set of data obtained via the first user interface, the prompt template including a set of instructions for the LLM to evaluate the set of data, where the set of instructions includes an indication of one or more fields of the set of multiple fields of the interactive data table, execute, via the LLM and based on receiving the prompt template, the set of instructions of the prompt template using the set of data of within the interactive data table to obtain a set of output data, and evaluate, via the LLM and in response to executing the prompt template, the set of output data according to obtain one or more indications of a performance of the prompt template.

Another apparatus for LLM prompt evaluation is described. The apparatus may include means for obtaining, via a first user interface, a set of data within an interactive data table, the interactive data table including a set of multiple fields and the set of multiple fields including a set of multiple data records from the set of data, means for receiving a prompt template for an LLM that is associated with evaluation of the set of data obtained via the first user interface, the prompt template including a set of instructions for the LLM to evaluate the set of data, where the set of instructions includes an indication of one or more fields of the set of multiple fields of the interactive data table, means for executing, via the LLM and based on receiving the prompt template, the set of instructions of the prompt template using the set of data of within the interactive data table to obtain a set of output data, and means for evaluating, via the LLM and in response to executing the prompt template, the set of output data according to obtain one or more indications of a performance of the prompt template.

A non-transitory computer-readable medium storing code for LLM prompt evaluation is described. The code may include instructions executable by one or more processors to obtain, via a first user interface, a set of data within an interactive data table, the interactive data table including a set of multiple fields and the set of multiple fields including a set of multiple data records from the set of data, receive a prompt template for an LLM that is associated with evaluation of the set of data obtained via the first user interface, the prompt template including a set of instructions for the LLM to evaluate the set of data, where the set of instructions includes an indication of one or more fields of the set of multiple fields of the interactive data table, execute, via the LLM and based on receiving the prompt template, the set of instructions of the prompt template using the set of data of within the interactive data table to obtain a set of output data, and evaluate, via the LLM and in response to executing the prompt template, the set of output data according to obtain one or more indications of a performance of the prompt template.

In some examples of the method, apparatus, and non-transitory computer-readable medium described herein, the one or more indications of the performance of the prompt template include a coherency indication, a relevance indication, an accuracy indication, or any combination thereof.

In some examples of the method, apparatus, and non-transitory computer-readable medium described herein, executing the set of instructions of the prompt template may include operations, features, means, or instructions for obtaining, from the set of data within the interactive data table, a subset of data associated with the one or more fields indicated via the set of instructions and transmitting, to the LLM, the set of instructions of the prompt template with the subset of data included within the set of instructions in place of the indication of the one or more fields, where the set of output data may be obtained based on the subset of data being included within the set of instructions.

In some examples of the method, apparatus, and non-transitory computer-readable medium described herein, executing the set of instructions of the prompt template may include operations, features, means, or instructions for displaying, via the first user interface, the set of output data within an output field of the set of multiple fields of the interactive data table.

In some examples of the method, apparatus, and non-transitory computer-readable medium described herein, the set of data includes text data, a single select data, multi-select data, numerical data, currency data, percentage data, one or more attachments, one or more formulas, record data, one or more images, audio data, or any combination thereof.

The following provides an overview of aspects of the present disclosure:

Aspect 1: A method for agent testing generation via a LLM, comprising: receiving, from a first user via a first user interface, a selection of one or more agents of a plurality of agents to perform a first task, the plurality of agents being associated with one or more AI/ML models to execute natural language queries, wherein each agent is associated with a set of parameters for performing one or more actions via the one or more AI/ML models; generating, via the LLM, a plurality of scenarios for testing the one or more agents, the plurality of scenarios corresponding to the one or more actions each agent of the one or more agents is instructed to perform based at least in part on the set of parameters of each agent; generating, via the LLM and based at least in part on generation of the plurality of scenarios, a set of training data for training the one or more agents to perform the first task, the set of training data being based at least in part on the set of parameters of the one or more agents and the plurality of scenarios; training the one or more AI/ML models associated with the one or more agents using the set of training data generated via the LLM; and executing the one or more agents to perform the first task based at least in part on training the one or more AI/ML models associated with the one or more agents.

Aspect 2: The method of aspect 1, further comprising: obtaining, in response to receiving the selection of the one or more agents, the set of parameters for each agent of the one or more agents, wherein generating the plurality of scenarios is based at least in part on obtaining the set of parameters for the one or more agents.

Aspect 3: The method of any of aspects 1 through 2, wherein receiving the selection of the one or more agents comprises: receiving, via the selection of the one or more agents, an indication of the first task for the one or more agents to perform, wherein executing the one or more agents to perform the first task is based at least in part on receiving the indication of the first task.

Aspect 4: The method of any of aspects 1 through 3, wherein training the one or more agents comprises: obtaining, from the one or more AI/ML models associated with the one or more agents, a set of output data in response to the set of training data being provided as input to the one or more AI/ML models, the set of output data being associated with the first task; and evaluating the set of output data to obtain a performance metric indication of the one or more agents.

Aspect 5: The method of aspect 4, wherein the set of output data is evaluated via code-based testing, via the LLM, via user feedback, or any combination thereof.

Aspect 6: The method of any of aspects 1 through 5, wherein the one or more agents are executed sequentially to perform the first task.

Aspect 7: A method for data evaluation via LLMs (LLMs), comprising: obtaining, via a first user interface, a set of data within an interactive data table, the interactive data table comprising a plurality of fields and the plurality of fields comprising a plurality of data records from the set of data; receiving a set of instructions for evaluation of the set of data within the interactive data table by an LLM, the set of instructions comprising an indication of one or more fields of the plurality of fields and an output format; evaluating, via the LLM and in accordance with the set of instructions for the evaluation, a subset of data of the set of data within the interactive data table, the subset of data being associated with the one or more fields of the interactive data table indicated via the set of instructions; and obtaining, from the LLM and based at least in part on the evaluation, a set of output data within the output format indicated via the set of instructions for the evaluation.

Aspect 8: The method of aspect 7, further comprising: obtaining, from one or more user inputs or from the LLM, an evaluation of the set of output data based at least in part on the set of output data from the LLM.

Aspect 9: The method of any of aspects 7 through 8, wherein obtaining the set of output data comprises: displaying, via the first user interface, the set of output data within an output field of the plurality of fields of the interactive data table.

Aspect 10: The method of any of aspects 7 through 9, wherein obtaining the set of data comprises: obtaining, via the first user interface, the set of data from a first user, from the LLM, or both.

Aspect 11: The method of aspect 10, wherein obtaining the set of data from the first user comprises: obtaining, from the first user and via the first user interface, the set of data via one or more user inputs comprising the set of data, via an indication of a file comprising the set of data, or a combination thereof.

Aspect 12: The method of any of aspects 10 through 11, wherein obtaining the set of data from the LLM comprises: transmitting, to the LLM, a query to generate the set of data, the query comprising one or more LLM prompt parameters for the LLM to utilize to generate the set of data.

Aspect 13: The method of any of aspects 7 through 12, wherein the set of data comprises text data, a single select data, multi-select data, numerical data, currency data, percentage data, one or more attachments, one or more formulas, record data, one or more images, audio data, or any combination thereof.

Aspect 14: The method of any of aspects 7 through 13, wherein the set of output data comprises textual data, numerical data, single tag data, multiple tag data, currency data, percentage data, or any combination thereof based at least in part on the output format indicated via the set of instructions for the evaluation of the set of data.

Aspect 15: The method of any of aspects 7 through 14, wherein the plurality of fields of the interactive data table are associated with a set of columns of the interactive data table.

Aspect 16: A method for LLM prompt evaluation, comprising: obtaining, via a first user interface, a set of data within an interactive data table, the interactive data table comprising a plurality of fields and the plurality of fields comprising a plurality of data records from the set of data; receiving a prompt template for an LLM that is associated with evaluation of the set of data obtained via the first user interface, the prompt template comprising a set of instructions for the LLM to evaluate the set of data, wherein the set of instructions comprises an indication of one or more fields of the plurality of fields of the interactive data table; executing, via the LLM and based at least in part on receiving the prompt template, the set of instructions of the prompt template using the set of data of within the interactive data table to obtain a set of output data; and evaluating, via the LLM and in response to executing the prompt template, the set of output data according to obtain one or more indications of a performance of the prompt template.

Aspect 17: The method of aspect 16, wherein the one or more indications of the performance of the prompt template comprise a coherency indication, a relevance indication, an accuracy indication, or any combination thereof.

Aspect 18: The method of any of aspects 16 through 17, wherein executing the set of instructions of the prompt template comprises: obtaining, from the set of data within the interactive data table, a subset of data associated with the one or more fields indicated via the set of instructions; and transmitting, to the LLM, the set of instructions of the prompt template with the subset of data included within the set of instructions in place of the indication of the one or more fields, wherein the set of output data is obtained based at least in part on the subset of data being included within the set of instructions.

Aspect 19: The method of any of aspects 16 through 18, wherein executing the set of instructions of the prompt template comprises: displaying, via the first user interface, the set of output data within an output field of the plurality of fields of the interactive data table.

Aspect 20: The method of any of aspects 16 through 19, wherein the set of data comprises text data, a single select data, multi-select data, numerical data, currency data, percentage data, one or more attachments, one or more formulas, record data, one or more images, audio data, or any combination thereof.

Aspect 21: An apparatus for agent testing generation via a LLM, comprising one or more memories storing processor-executable code, and one or more processors coupled with the one or more memories and individually or collectively operable to execute the code to cause the apparatus to perform a method of any of aspects 1 through 6.

Aspect 22: An apparatus for agent testing generation via a LLM, comprising at least one means for performing a method of any of aspects 1 through 6.

Aspect 23: A non-transitory computer-readable medium storing code for agent testing generation via a LLM, the code comprising instructions executable by one or more processors to perform a method of any of aspects 1 through 6.

Aspect 24: An apparatus for data evaluation via LLMs (LLMs), comprising one or more memories storing processor-executable code, and one or more processors coupled with the one or more memories and individually or collectively operable to execute the code to cause the apparatus to perform a method of any of aspects 7 through 15.

Aspect 25: An apparatus for data evaluation via LLMs (LLMs), comprising at least one means for performing a method of any of aspects 7 through 15.

Aspect 26: A non-transitory computer-readable medium storing code for data evaluation via LLMs (LLMs), the code comprising instructions executable by one or more processors to perform a method of any of aspects 7 through 15.

Aspect 27: An apparatus for LLM prompt evaluation, comprising one or more memories storing processor-executable code, and one or more processors coupled with the one or more memories and individually or collectively operable to execute the code to cause the apparatus to perform a method of any of aspects 16 through 20.

Aspect 28: An apparatus for LLM prompt evaluation, comprising at least one means for performing a method of any of aspects 16 through 20.

Aspect 29: A non-transitory computer-readable medium storing code for LLM prompt evaluation, the code comprising instructions executable by one or more processors to perform a method of any of aspects 16 through 20.

It should be noted that the methods described above describe possible implementations, and that the operations and the steps may be rearranged or otherwise modified and that other implementations are possible. Furthermore, aspects from two or more of the methods may be combined.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable ROM (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method for agent testing generation via a large language model (LLM), comprising:
receiving, from a first user via a first user interface, a selection of one or more agents of a plurality of agents to perform a first task, the plurality of agents being associated with one or more artificial intelligence or machine learning (AI/ML) models to execute natural language queries, wherein each agent is associated with a set of parameters for performing one or more actions via the one or more AI/ML models;
generating, via the LLM, a plurality of scenarios for testing the one or more agents, the plurality of scenarios corresponding to the one or more actions each agent of the one or more agents is instructed to perform based at least in part on the set of parameters of each agent;
generating, via the LLM and based at least in part on generation of the plurality of scenarios, a set of training data for training the one or more agents to perform the first task, the set of training data being based at least in part on the set of parameters of the one or more agents and the plurality of scenarios;
training the one or more AI/ML models associated with the one or more agents using the set of training data generated via the LLM; and
executing the one or more agents to perform the first task based at least in part on training the one or more AI/ML models associated with the one or more agents.

2. The method of claim 1, further comprising:
obtaining, in response to receiving the selection of the one or more agents, the set of parameters for each agent of the one or more agents, wherein generating the plurality of scenarios is based at least in part on obtaining the set of parameters for the one or more agents.

3. The method of claim 1, wherein receiving the selection of the one or more agents comprises:
receiving, via the selection of the one or more agents, an indication of the first task for the one or more agents to perform, wherein executing the one or more agents to perform the first task is based at least in part on receiving the indication of the first task.

4. The method of claim 1, wherein training the one or more agents comprises:
obtaining, from the one or more AI/ML models associated with the one or more agents, a set of output data in response to the set of training data being provided as input to the one or more AI/ML models, the set of output data being associated with the first task; and
evaluating the set of output data to obtain a performance metric indication of the one or more agents.

5. The method of claim 4, wherein the set of output data is evaluated via code-based testing, via the LLM, via user feedback, or any combination thereof.

6. The method of claim 1, wherein the one or more agents are executed sequentially to perform the first task.

7. A method for data evaluation via large language models (LLMs), comprising:
obtaining, via a first user interface, a set of data within an interactive data table, the interactive data table comprising a plurality of fields and the plurality of fields comprising a plurality of data records from the set of data;
receiving a set of instructions for evaluation of the set of data within the interactive data table by an LLM, the set of instructions comprising an indication of one or more fields of the plurality of fields and an output format;
evaluating, via the LLM and in accordance with the set of instructions for the evaluation, a subset of data of the set of data within the interactive data table, the subset of data being associated with the one or more fields of the interactive data table indicated via the set of instructions; and
obtaining, from the LLM and based at least in part on the evaluation, a set of output data within the output format indicated via the set of instructions for the evaluation.

8. The method of claim 7, further comprising:
obtaining, from one or more user inputs or from the LLM, an evaluation of the set of output data based at least in part on the set of output data from the LLM.

9. The method of claim 7, wherein obtaining the set of output data comprises:
displaying, via the first user interface, the set of output data within an output field of the plurality of fields of the interactive data table.

10. The method of claim 7, wherein obtaining the set of data comprises:
obtaining, via the first user interface, the set of data from a first user, from the LLM, or both.

11. The method of claim 10, wherein obtaining the set of data from the first user comprises:
obtaining, from the first user and via the first user interface, the set of data via one or more user inputs comprising the set of data, via an indication of a file comprising the set of data, or a combination thereof.

12. The method of claim 10, wherein obtaining the set of data from the LLM comprises:
transmitting, to the LLM, a query to generate the set of data, the query comprising one or more LLM prompt parameters for the LLM to utilize to generate the set of data.

13. The method of claim 7, wherein the set of data comprises text data, a single select data, multi-select data, numerical data, currency data, percentage data, one or more attachments, one or more formulas, record data, one or more images, audio data, or any combination thereof.

14. The method of claim 7, wherein the set of output data comprises textual data, numerical data, single tag data, multiple tag data, currency data, percentage data, or any combination thereof based at least in part on the output format indicated via the set of instructions for the evaluation of the set of data.

15. The method of claim 7, wherein the plurality of fields of the interactive data table are associated with a set of columns of the interactive data table.

16. A method for large language model (LLM) prompt evaluation, comprising:
obtaining, via a first user interface, a set of data within an interactive data table, the interactive data table comprising a plurality of fields and the plurality of fields comprising a plurality of data records from the set of data;
receiving a prompt template for an LLM that is associated with evaluation of the set of data obtained via the first user interface, the prompt template comprising a set of instructions for the LLM to evaluate the set of data, wherein the set of instructions comprises an indication of one or more fields of the plurality of fields of the interactive data table;
executing, via the LLM and based at least in part on receiving the prompt template, the set of instructions of the prompt template using the set of data of within the interactive data table to obtain a set of output data; and
evaluating, via the LLM and in response to executing the prompt template, the set of output data according to obtain one or more indications of a performance of the prompt template.

17. The method of claim 16, wherein the one or more indications of the performance of the prompt template comprise a coherency indication, a relevance indication, an accuracy indication, or any combination thereof.

18. The method of claim 16, wherein executing the set of instructions of the prompt template comprises:
obtaining, from the set of data within the interactive data table, a subset of data associated with the one or more fields indicated via the set of instructions; and
transmitting, to the LLM, the set of instructions of the prompt template with the subset of data included within the set of instructions in place of the indication of the one or more fields, wherein the set of output data is obtained based at least in part on the subset of data being included within the set of instructions.

19. The method of claim 16, wherein executing the set of instructions of the prompt template comprises:
displaying, via the first user interface, the set of output data within an output field of the plurality of fields of the interactive data table.

20. The method of claim 16, wherein the set of data comprises text data, a single select data, multi-select data, numerical data, currency data, percentage data, one or more attachments, one or more formulas, record data, one or more images, audio data, or any combination thereof.
